(19) United States
(12) Patent Application Publication
(10) Pub. No.: US 2024/0248947 A1
(43) Pub. Date: Jul. 25, 2024

(54) SYSTEMS AND METHODS FOR IMPROVING COMPUTATIONAL EFFICIENCY OF PROCESSOR-BASED DEVICES IN SOLVING CONSTRAINED QUADRATIC MODELS

(71) Applicant: D-WAVE SYSTEMS INC., Burnaby (CA)

(72) Inventors: Hossein Sadeghi Esfahani, Vancouver (CA); Mohsen Rahmani, Portland, OR (US); Alex Zucca, Coquitlam (CA); William W. Bernoudy, Vancouver (CA)

(21) Appl. No.: 18/286,624

(22) PCT Filed: Mar. 30, 2022
(86) PCT No.: PCT/IB2022/000201

§ 371 Date: Oct. 12, 2023

Related U.S. Application Data
(60) Provisional application No. 63/174,097, filed on Apr. 13, 2021.
(60) Provisional application No. 63/250,466, filed on Sep. 30, 2021.

(51) Int. Cl. G06F 17/11

(52) U.S. Cl. CPC G06F 17/11

(57) ABSTRACT

Systems and methods for optimization algorithms, updating samples, and penalizing constraint violations are discussed. A method for updating samples includes receiving a problem definition with an objective function and constraint functions, an initial sample, and a value for a progress parameter. For each variable a total energy change is determined based on an objective energy change based on the sample value for the variable and one or more terms of the objective function that include the variable and a constraint energy change based on the sample value for the variable and each of the constraint functions defined by the variable. A sampling distribution is selected based on the variable type and an updated value is sampled based on the total energy change and the progress parameter. An updated sample is returned with an updated value for each variable of the set of variables. Such may improve operation of processor-based systems.

### FIELD

This disclosure generally relates to systems and methods for improving efficiency of processor-based devices in solving constrained quadratic models, for instance employing a hybrid approach that takes advantage of digital processors and analog processors.

### BACKGROUND

### Quantum Devices

Quantum devices are structures in which quantum mechanical effects are observable. Quantum devices include circuits in which current transport is dominated by quantum mechanical effects. Such devices include spintronics and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as superposition, tunneling, and entanglement, to perform operations on data. The elements of a quantum computer are qubits. Quantum computers can provide speedup for certain classes of computational problems such as computational problems simulating quantum physics.

### Quantum Processor

A quantum processor may take the form of a superconducting quantum processor. A superconducting quantum processor may include a number of superconducting qubits and associated local bias devices. A superconducting quantum processor may also include coupling devices (also known as couplers or qubit couplers) that selectively provide communicative coupling between qubits.

A quantum processor is any computer processor that is designed to leverage at least one quantum mechanical phenomenon (such as superposition, entanglement, tunneling, etc.) in the processing of quantum information. Regardless of the specific hardware implementation, all quantum processors encode and manipulate quantum information in quantum mechanical objects or devices called quantum bits, or “qubits;” all quantum processors employ structures or devices for communicating information between qubits; and all quantum processors employ structures or devices for reading out a state of at least one qubit. A quantum processor may include a large number (e.g., hundreds, thousands, millions, etc.) of programmable elements, including but not limited to: qubits, couplers, readout devices, latching devices (e.g., quantum flux parametron latching circuits), shift registers, digital-to-analog converters, and/or demultiplexer trees, as well as programmable sub-components of these elements such as programmable sub-components for correcting device variations (e.g., inductance tuners, capacitance tuners, etc.), programmable sub-components for compensating unwanted signal drift, and so on.

Further details and embodiments of exemplary quantum processors that may be used in conjunction with the present systems and devices are described in, for example, U.S. Pat. Nos. 7,533,068; 8,008,942; 8,195,596; 8,190,548; and 8,421,053.

### Hybrid Computing System Comprising a Quantum Processor

A hybrid computing system can include a digital computer communicatively coupled to an analog computer. In some implementations, the analog computer is a quantum computer, and the digital computer is a classical computer.

The digital computer can include a digital processor that can be used to perform classical digital processing tasks described in the present systems and methods. The digital computer can include at least one system memory which can be used to store various sets of computer- or processor-readable instructions, application programs and/or data.

The quantum computer can include a quantum processor that includes programmable elements such as qubits, couplers, and other devices. The qubits can be read out via a readout system, and the results communicated to the digital computer. The qubits and the couplers can be controlled by a qubit control system and a coupler control system, respectively. In some implementations, the qubit and the coupler control systems can be used to implement quantum annealing on the analog computer.

### Quantum Annealing

Quantum annealing is a computational method that may be used to find a low-energy state of a system, typically preferably the ground state of the system. The method relies on the underlying principle that natural systems tend towards lower energy states, as lower energy states are more stable. Quantum annealing may use quantum effects, such as quantum tunneling, as a source of delocalization to reach an energy minimum.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

H_{E}∝A(t)H_{P}+B(t)H_{D}

where H_{E} is the evolution Hamiltonian, H_{P} is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$${H}_{D} ∝ - \frac{1}{2} {\sum }_{i = 1}^{N} {Δ}_{i} {σ}_{i}^{x}$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {\sum }_{i = 1}^{N} {h}_{i} {σ}_{i}^{z} + {\sum }_{j > i}^{N} {J}_{i j} {σ}_{i}^{z} {σ}_{j}^{z} ]$$

where N represents the number of qubits, σᵢ^{x} is the Pauli z-matrix for the i^{th} qubit, hᵢ and Jᵢⱼ are dimensionless local fields for the qubits, and couplings between qubits, and E is some characteristic energy scale for Hₚ.

Here, the σᵢ^{z} and σᵢ^{z} σⱼ^{z} terms are examples of “diagonal” terms. The former is a single qubit term and the latter a two-qubit term.

Throughout this specification, the terms “problem Hamiltonian” and “final Hamiltonian” are used interchangeably unless the context dictates otherwise. Certain states of the quantum processor are energetically preferred, or simply preferred, by the problem Hamiltonian. These include the ground states and may include excited states.

Hamiltonians such as H_{D} and H_{P} in the above two equations may be physically realized in a variety of different ways. A particular example is realized by an implementation of superconducting qubits.

### Sampling

Throughout this specification and the appended claims, the terms “sample”, “sampling”, “sampling device”, and “sample generator” are used.

In statistics, a sample is a subset of a population, i.e., a selection of data taken from a statistical population. In electrical engineering and related disciplines, sampling relates to taking a set of measurements of an analog signal or some other physical system.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population. The population can correspond to all possible states of the processor, and each sample can correspond to a respective state of the processor.

### Markov Chain Monte Carlo

Markov Chain Monte Carlo (MCMC) is a class of computational techniques which include, for example, simulated annealing, parallel tempering, population annealing, and other techniques. A Markov chain may be used, for example when a probability distribution cannot be used. A Markov chain may be described as a sequence of discrete random variables, and/or as a random process where at each time increment the state only depends on the previous state. When the chain is long enough, aggregate properties of the chain, such as the mean, can match aggregate properties of a target distribution.

The Markov chain can be obtained by proposing a new point according to a Markovian proposal process (generally referred to as an “update operation”). The new point is either accepted or rejected. If the new point is rejected, a new proposal is made, and so on. New points that are accepted are ones that make for a probabilistic convergence to the target distribution. Convergence is guaranteed if the proposal and acceptance criteria satisfy detailed balance conditions, and the proposal satisfies the ergodicity requirement. Further, the acceptance of a proposal can be done such that the Markov chain is reversible, i.e., the product of transition rates over a closed loop of states in the chain is the same in either direction. A reversible Markov chain is also referred to as having detailed balance. Typically, in many cases, the new point is local to the previous point.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Improving the computational efficiency and/or accuracy of the operation of processor-based devices is generally desirable and is particularly desirable in the case of using processor-based devices as solves to solve constrained quadratic models.

One method of addressing constraints when solving an optimization problem is to convert the constraints to part of the objective function using slack variables, and then minimize over the new objective function. However, in some implementations, this may result in a high computational cost, such as long processing times, high numbers of slack variables being required, and/or significantly increased complexity of solution. The present disclosure describes systems and methods useful in improving computational efficiency when solving constrained quadratic problems. In particular, the presently described systems and methods may allow for specifying constraints without the requirement to convert them and include them in the objective function.

In order to allow some flexibility in solving while also ensuring that constraints are satisfied, a penalty value may be assigned to the constraints, allowing the weight that the constraints are given to be varied, such that the constraint may be violated in some circumstances (such as at the start of a simulated annealing). When adding constraints to an objective function, a penalty value for the constraint may need to be selected without any guidance as to an appropriate penalty value in the given problem. This may result in the need to solve the problem multiple times with different penalty values to find better solutions. The presently described systems and methods may also allow for selecting a penalty value without solving the problem multiple times with different penalty values, and for dynamic adjustment of the penalty value during the solving process.

The methods and systems described herein beneficially allow for computationally efficient solving optimization problems with constraints by handling the constraints directly as opposed to converting them to part of an objective function. This may beneficially allow a processor to return feasible solutions to an optimization problem in a time efficient and scalable manner. This may also allow for the generation of multiple solutions in parallel by the processor. The contributions of the constraints may be handled implicitly through an update process that considers each constraint. Handling the constraint functions directly and pulling energy values for the constraint functions through the computations may increase the efficiency of solutions. The methods and systems described herein may also advantageously allow for automatic and dynamic adjustment of penalty weights for the constraint functions, allowing for the search to be efficiently directed toward feasibility while returning better solutions. Many real-world problems, such as those solved in industry, are problems having constraints on viable solutions. The methods and systems described herein may also allow for solution of problems having a set of variables with different types, such as a mixture of binary and discrete variables. Sampling may be done based on a determination of the variable type and considering the current energy values and penalties. In some implementations, the methods and systems described herein may be used in combination with hybrid quantum computing techniques to provide improved solutions.

According to an aspect, there is provided a method of operation of a computing system to update a sample in an optimization algorithm to improve convergence to feasibility, the method being performed by a processor, the method comprising receiving a problem definition comprising a set of variables, an objective function defined over the set of variables, and one or more constraint functions, each of the constraint functions defined by at least one variable of the set of variables, receiving sample values for the set of variables and a value for a progress parameter, for each variable of the set of variables determining a variable type for the variable, selecting a sampling distribution based on the variable type, determining an objective energy bias based on the sample value for the variable and one or more terms of the objective function that include the variable, determining one or more constraint energy biases based on the sample value for the variable and each of the constraint functions defined by the variable, and sampling an updated value for the variable from the sampling distribution based on the objective energy bias, the one or more constraint energy biases, and the progress parameter, and returning an updated sample, the updated sample comprising the updated value for each variable of the set of variables.

According to other aspects the method may further comprise receiving a value for a penalty parameter, and sampling an updated value for the variable from the sampling distribution may further comprise sampling an updated value for the variable from the sampling distribution based on the value for a penalty parameter, receiving a value for the penalty parameter may comprise receiving a value for a Lagrange parameter that depends on the value for the progress parameter, determining the variable type for the variable may comprise determining that the variable type is one of binary, discrete, integer, or continuous, determining that the variable type is one of binary, discrete, integer, or continuous may comprise determining that the variable type is binary, and wherein selecting a sampling distribution based on the variable type may comprise selecting a Bernoulli distribution, determining that the variable type is one of binary, discrete, integer, or continuous may comprise determining that the variable type is discrete, and selecting a sampling distribution based on the variable type may comprise selecting a SoftMax distribution, determining that the variable type is one of binary, discrete, integer, or continuous may comprise determining that the variable type is one of integer or continuous, and selecting a sampling distribution based on the variable type may comprise selecting a conditional probability distribution, wherein sampling an updated value from the sampling distribution may comprise slice sampling from the conditional probability distribution, and receiving the value for the progress parameter may comprise receiving an inverse temperature.

According to an aspect, there is provided a system for updating a sample in an optimization algorithm, the system comprising at least one non-transitory processor-readable medium that stores at least one of processor executable instructions and data and at least one processor communicatively coupled to the least one non-transitory processor-readable medium, which, in response to execution of the at least one of processor executable instructions and data performs a method as described herein.

According to an aspect, there is provided a method of operation of a computing system, the computing system comprising one or more processors, the method being performed by at least one of the one or more processors, the method comprising receiving a problem definition comprising a set of variables, an objective function defined over the set of variables, and one or more constraint functions, each of the constraint functions defined by at least one variable of the set of variables, initializing a sample solution to the objective function and a progress parameter, iteratively until a termination criteria is met incrementing a stage of an optimization algorithm, for each variable in the set of variables selecting an i^{th} variable from the set of variables, the i^{th} variable having a current value, calculating an objective energy bias for the objective function based on the current value of the i^{th} variable, calculating a constraint energy bias for each constraint function defined by the i^{th} variable based on the current value of the i^{th} variable, and sampling an updated value for the i^{th} variable based on the objective energy bias and the constraint energy bias, the updated value replacing the current value, incrementing a progress parameter, evaluating a termination criteria, and outputting a solution comprising the current values for the set of variables.

According to other aspects selecting an i^{th} variable from the set of variables may comprise selecting a binary variable, the binary variable having a current value and an alternative value, calculating an objective energy bias for the objective function based on the current value of the i^{th} variable may comprise calculating a difference in energy for the objective function between the current value and the alternative value for the binary variable, calculating a constraint energy bias based on each constraint function defined by the i^{th} variable based on the current value of the i^{th} variable may comprise calculating a difference in energy for each constraint function defined by the binary variable between the current value of the binary variable and the alternative value for the binary variable, and sampling an updated value for the i^{th} variable based on the objective energy bias and the constraint energy bias may comprise sampling an updated value for the i^{th} variable based on the difference in energy values for the objective function and each constraint function defined by the fh variable.

According to other aspects, the method may further comprise initializing a penalty parameter, adjusting the penalty parameter for each constraint function based on the difference in energy for the constraint function defined by the i^{th} variable and the progress parameter, and wherein calculating the difference in energy for each constraint function defined by the i^{th} variable includes penalizing each constraint function by the penalty parameter, incrementing a stage of an optimization algorithm for the objective function may include incrementing one of a simulated annealing or a parallel tempering algorithm, receiving a problem definition comprising an objective function and one or more constraint functions may comprise receiving a problem definition comprising a quadratic objective function and one or more quadratic equality or inequality constraint functions, receiving a problem definition comprising a set of variables may comprise receiving a problem definition comprising a set of one or more of binary, integer, or discrete variables, receiving a problem definition comprising a set of variables may comprise receiving a problem definition comprising one or more integer variables, and sampling an updated value for the i^{th} variable may comprise performing sampling from a conditional probability distribution, the i^{th} variable comprising an integer variable from the one or more integer variables, and the termination criteria may comprise one of a number of iterations, an amount of time, an average change in value limit, or a value of the progress parameter.

According to an aspect, there is provided a system for use in optimization, the system comprising at least one non-transitory processor-readable medium that stores at least one of processor executable instructions and data and at least one processor communicatively coupled to the least one non-transitory processor-readable medium, which, in response to execution of the at least one of processor executable instructions and data, performs a method as described herein.

According to other aspects, the system may further comprise a quantum processor, and wherein, after performing the method, the at least one processor may instruct the quantum processor to perform quantum annealing based on the outputted solution.

According to an aspect, there is provided a method of operation of a hybrid computing system, the hybrid computing system comprising a quantum processor and a classical processor, the method being performed by the classical processor, the method comprising receiving a constrained quadratic optimization problem, the constrained quadratic optimization problem comprising a set of variables, an objective function defined over the set of variables, one or more constraint functions, each of the constraint functions defined by at least one variable of the set of variables, and a progress parameter for the optimization, the progress parameter comprising a set of values incrementing between an initial value and a final value, iteratively until the final value of the progress parameter is reached sampling a sample set of values for the set of variables from an optimization algorithm, updating the sample set of values with an update algorithm comprising for each variable of the set of variables determining a variable type for the variable, selecting a sampling distribution based on the variable type, determining an objective energy bias based on a sample value for the variable from the sample set of values and one or more terms of the objective function that include the variable, determining one or more constraint energy bias based on the sample value for the variable and each of the constraint functions defined by the variable, and sampling an updated value for the variable from the sampling distribution based on the objective energy bias, the one or more constraint energy biases, and the progress parameter, and returning an updated sample, the updated sample comprising the updated value for each variable of the set of variables, incrementing the progress parameter, transmitting one or more final samples to a quantum processor, instructing the quantum processor to refine the samples, and outputting solutions.

According to other aspects, transmitting one or more final samples to a quantum processor may comprise transmitting pairs of samples to the quantum processor, and wherein instructing the quantum processor to refine the samples comprises instructing the quantum processor to perform quantum annealing to select between the samples, and the method may further comprise returning the outputted solutions as a sample set of values for the set of variables as an input to the optimization algorithm.

According to an aspect, there is provided a hybrid computing system, the hybrid computing system comprising a quantum processor and a classical processor, at least one non-transitory processor-readable medium that stores at least one of processor executable instructions and data, and at least one processor communicatively coupled to the least one non-transitory processor-readable medium, which, in response to execution of the at least one of processor executable instructions and data, performs a method as described herein.

According to an aspect, there is provided a method of operation of a computing system to direct a search space towards feasibility to improve performance of the computing system, the computing system comprising one or more processors, the method being performed by at least one of the one or more processors, the method comprising receiving a sample from an optimization, determining an energy value for one or more constraint functions, evaluating feasibility of the sample, if the sample is not feasible, increasing a penalty value, if the sample is feasible, decreasing a penalty value, and returning a penalty value to an optimization algorithm.

According to other aspects, the method may further comprise determining if a violation has been reduced in comparison with a previous sample and increasing an initial adjuster value if the violation has not been reduced and determining if a current best solution has been improved in comparison with a previous sample and increasing an initial adjuster value if the current best solution has not been improved.

According to an aspect, there is provided a method of operation of a computing system, the computing system comprising one or more processors, the method being performed by at least one of the one or more processors, the method comprising: receiving a problem definition comprising a set of variables, an objective function defined over the set of variables, and one or more constraint functions, each of the constraint functions defined by at least one variable of the set of variables, the set of variables comprising a first subset of variables having at least one variable that is one of binary, integer, discrete, or continuous and a second subset of variables having at least one variable that is continuous, initializing a sample solution to the objective function and a progress parameter, initializing a continuous problem defined over the second subset of variables, the continuous problem comprising a linear programming model, iteratively until a termination criteria is met: incrementing a stage of an optimization algorithm, for each variable in the first subset of variables: determining a variable type for the variable, selecting a sampling distribution based on the variable type, determining an objective energy bias based on the sample value for the variable and one or more terms of the objective function that include the variable, determining one or more constraint energy biases based on the sample value for the variable and each of the constraint functions defined by the variable, sampling an updated value for the variable from the sampling distribution based on the objective energy bias, the one or more constraint energy biases, and the progress parameter, and returning an updated sample, the updated sample comprising the updated value for each variable of the set of variables, solving the linear programming model for the second subset of variables with the values for each variable in the first subset of variables fixed at the updated value, sampling an updated value for each variable in the second subset of variables based on the solved linear programming model, the updated value replacing a current value, updating the objective energy bias and the one or more constraint energy biases based on the updated values for the second subset of variables, incrementing the progress parameter, evaluating a termination criteria, and outputting a solution comprising the updated values for the set of variables.

According to other aspects, the method may further comprise initializing one or more penalty parameters, wherein sampling an updated value for the variable from the sampling distribution further comprises sampling an updated value for the variable from the sampling distribution based on at least one value for the one or more penalty parameters, and wherein sampling an updated value for each variable in the second subset of variables comprises sampling an updated value for each variable in the second subset of variables based on the solved linear programming model and at least one value for the one or more penalty parameters, initializing one or more penalty parameters may comprise initializing at least one Lagrange parameter that depends on the value for the progress parameter, determining the variable type for the variable may comprise determining that the variable type is one of binary, discrete, integer, or continuous, determining that the variable type is one of binary, discrete, integer, or continuous may comprise determining that the variable type is binary, and wherein selecting a sampling distribution based on the variable type comprises selecting a Bernoulli distribution, determining that the variable type is one of binary, discrete, integer, or continuous may comprise determining that the variable type is discrete, and wherein selecting a sampling distribution based on the variable type comprises selecting a SoftMax distribution, determining that the variable type is one of binary, discrete, integer, or continuous may comprise determining that the variable type is one of integer and continuous, selecting a sampling distribution based on the variable type may comprise selecting a conditional probability distribution, sampling an updated value for the variable from the sampling distribution may comprise slice sampling from the conditional probability distribution, receiving the value for the progress parameter may comprise receiving an inverse temperature, incrementing a stage of an optimization algorithm for the objective function may include incrementing one of a simulated annealing or a parallel tempering algorithm, receiving a problem definition comprising an objective function and one or more constraint functions may comprise receiving a problem definition comprising a quadratic objective function and one or more quadratic equality or inequality constraint functions, and the termination criteria may comprise one of a number of iterations, an amount of time, an average change in value limit, or a value of the progress parameter.

According to an aspect, there is provided a system for use in optimization, the system comprising: at least one non-transitory processor-readable medium that stores at least one of processor executable instructions and data and at least one processor communicatively coupled to the least one non-transitory processor-readable medium, which, in response to execution of the at least one of processor executable instructions and data, performs a method as described herein.

According to other aspects, the system may further comprise a quantum processor, and, after performing a method as described herein, the at least one processor instructs the quantum processor to perform quantum annealing based on the outputted solution.

In other aspects, the features described above may be combined together in any reasonable combination as will be recognized by those skilled in the art.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements and may have been solely selected for ease of recognition in the drawings.

FIG. 1 is a schematic diagram of a hybrid computing system including a digital computer coupled to an analog computer, in accordance with the present systems, devices, and methods.

FIG. 2 is a schematic diagram of a portion of an exemplary superconducting quantum processor.

FIG. 3 is a flow diagram of an example method for performing sampling in an optimization algorithm.

FIG. 4 is a flow diagram of an example method of operation of a computing system for finding a solution to a constrained problem.

FIG. 5 is a flow diagram of another example method of operation of a computing system for finding a solution to a constrained problem.

FIG. 6 is a flow diagram of an example method of operation of a hybrid computing system.

FIG. 7 is an illustration of functions for constraints for equalities and inequalities.

FIG. 8 is a flow diagram of an example method for adjusting penalty parameters to direct a search space toward feasibility.

FIG. 9 is a flow diagram of another example method for adjusting penalty parameters to direct a search space toward feasibility.

FIG. 10 is a diagram of the domain of variable xₖ used in calculating a partition function.

FIG. 11 is a diagram of the general case of a partition function for a segment S.

FIG. 12 is a diagram of an example probability distribution for a binary variable based on an energy bias and a progress parameter.

FIG. 13 is a diagram of an example probability distribution function for continuous variables.

FIG. 14 is a flow diagram of an example method of operation of a computing system for finding a solution to a constrained problem having continuous variables.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure, or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

As an illustrative example, a superconducting quantum processor designed to perform adiabatic quantum computation and/or quantum annealing is used in the description that follows. However, as previously described, a person of skill in the art will appreciate that the present systems and methods may be applied to any form of quantum processor hardware (e.g., superconducting, photonic, ion-trap, quantum dot, topological, etc.) implementing any form of quantum algorithm(s) (e.g., adiabatic quantum computation, quantum annealing, gate/circuit-based quantum computing, etc.). A quantum processor may be used in combination with one or more classical or digital processors. Methods described herein may be performed by a classical or digital processor in communication with a quantum processor that implements a quantum algorithm.

### Exemplary Computing System

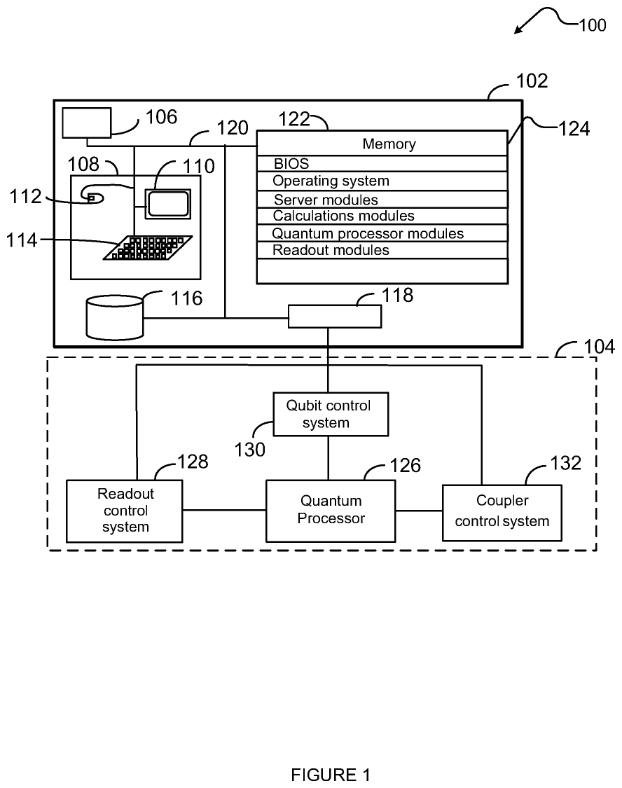

FIG. 1 illustrates a computing system 100 comprising a digital computer 102. The example digital computer 102 includes one or more digital processors 106 that may be used to perform classical digital processing tasks. Digital computer 102 may further include at least one system memory 122, and at least one system bus 120 that couples various system components, including system memory 122 to digital processor(s) 106. System memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, as described in greater detail herein.

Digital computer 102 may include a user input/output subsystem 108. In some implementations, the user input/output subsystem includes one or more user input/output components such as a display 110, mouse 112, and/or keyboard 114.

System bus 120 may employ any known bus structures or architectures, including a memory bus with a memory controller, a peripheral bus, and a local bus. System memory 122 may include non-volatile memory, such as read-only memory (“ROM”), static random-access memory (“SRAM”), Flash NAND; and volatile memory such as random-access memory (“RAM”) (not shown).

Digital computer 102 may also include other non-transitory computer- or processor-readable storage media or non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid-state drive (SSD) for reading from and writing to solid state media (for example NAND-based Flash memory). Non-volatile memory 116 may communicate with digital processor(s) via system bus 120 and may include appropriate interfaces or controllers 118 coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of nontransitory and non-volatile computer-readable media may be employed. Those skilled in the relevant art will appreciate that some computer architectures employ nontransitory volatile memory and nontransitory non-volatile memory. For example, data in volatile memory may be cached to non-volatile memory. Or a solid-state disk that employs integrated circuits to provide non-volatile memory.

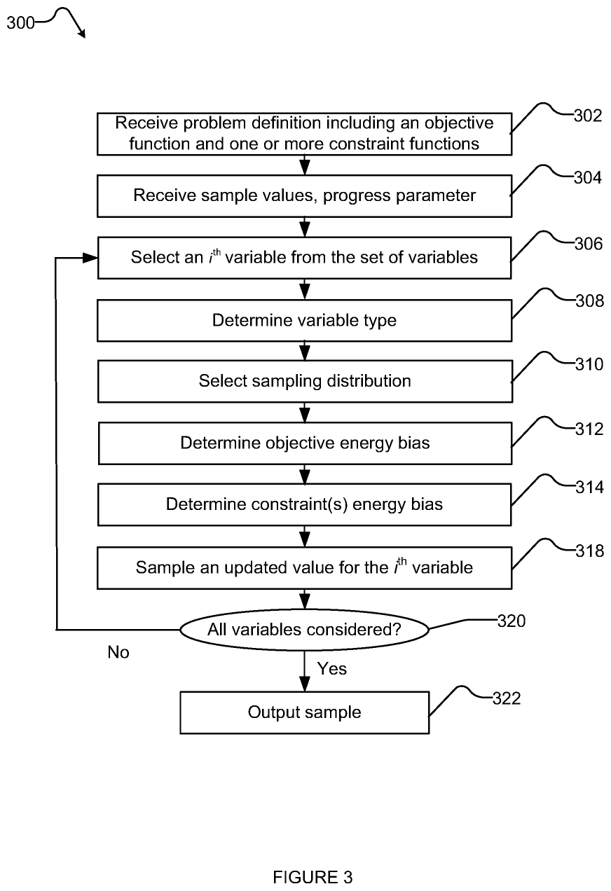

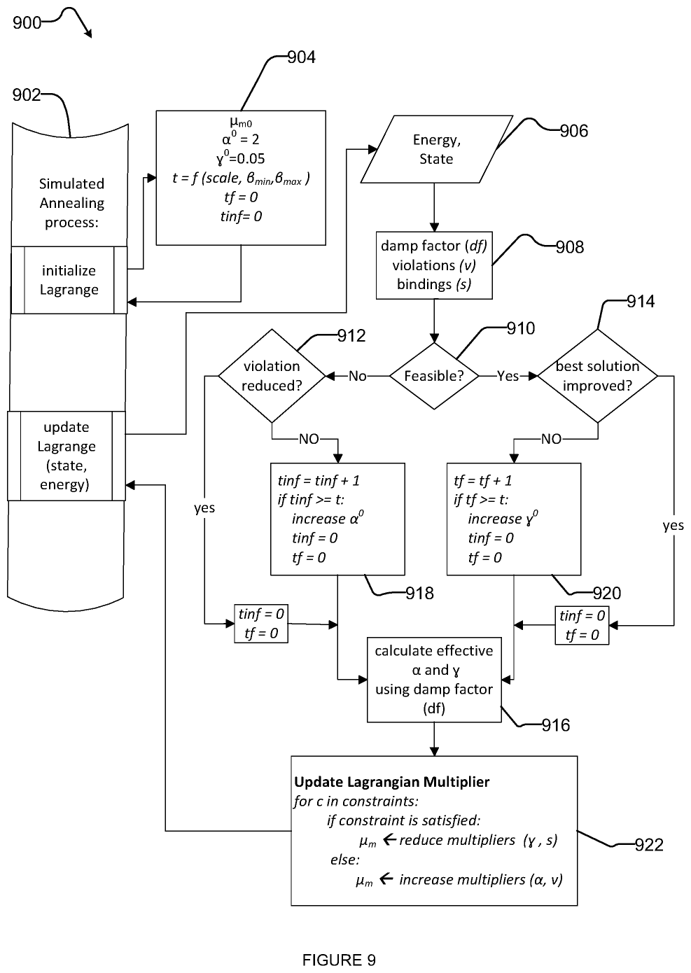

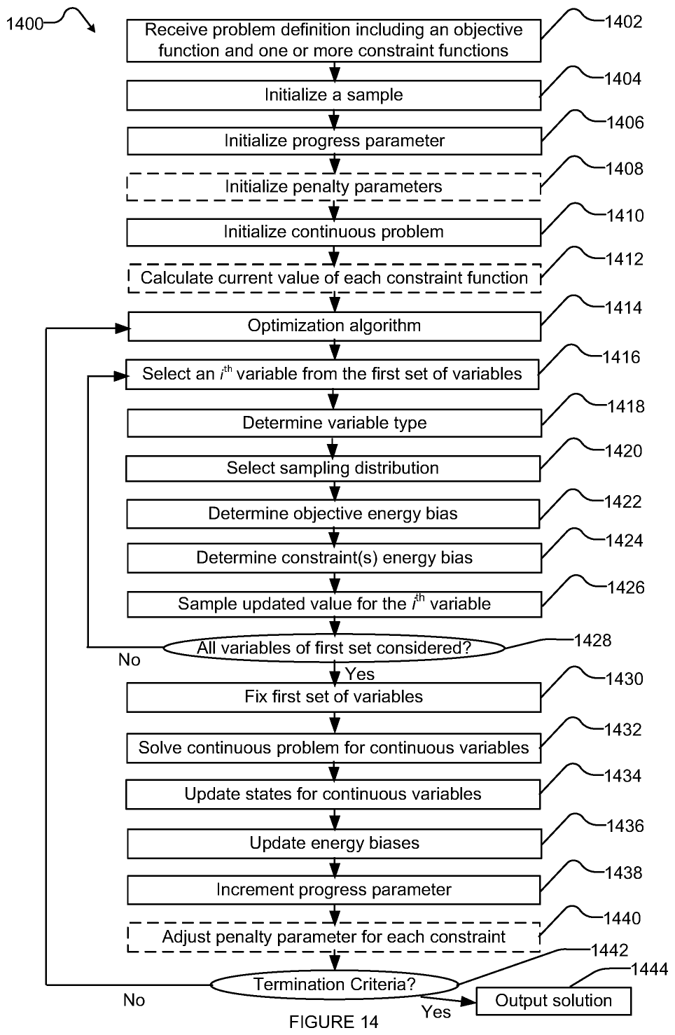

Various processor- or computer-readable and/or executable instructions, data structures, or other data may be stored in system memory 122. For example, system memory 122 may store instructions for communicating with remote clients and scheduling use of resources including resources on the digital computer 102 and analog computer 104. Also, for example, system memory 122 may store at least one of processor executable instructions or data that, when executed by at least one processor, causes the at least one processor to execute the various algorithms to execute instructions. In some implementations system memory 122 may store processor- or computer-readable calculation instructions and/or data to perform pre-processing, co-processing, and post-processing to analog computer 104. System memory 122 may store a set of analog computer interface instructions to interact with analog computer 104. For example, the system memory 122 may store processor- or computer-readable instructions, data structures, or other data which, when executed by a processor or computer causes the processor(s) or computer(s) to execute one, more or all of the acts of the methods 300 (FIG. 3) through 900 (FIG. 9) and 1400 (FIG. 14).

Analog computer 104 may include at least one analog processor such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Analog computer 104 may include programmable elements such as qubits, couplers, and other devices (also referred to herein as controllable devices). Qubits may be read out via readout system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines. Qubit control system 130 and coupler control system 132 may be used to implement a quantum annealing schedule as described herein on analog processor 104. Programmable elements may be included in quantum processor 126 in the form of an integrated circuit. Qubits and couplers may be positioned in layers of the integrated circuit that comprise a first material. Other devices, such as readout control system 128, may be positioned in other layers of the integrated circuit that comprise a second material. In accordance with the present disclosure, a quantum processor, such as quantum processor 126, may be designed to perform quantum annealing and/or adiabatic quantum computation. Examples of quantum processors are described in U.S. Pat. No. 7,533,068.

### Exemplary Superconducting Quantum Processor

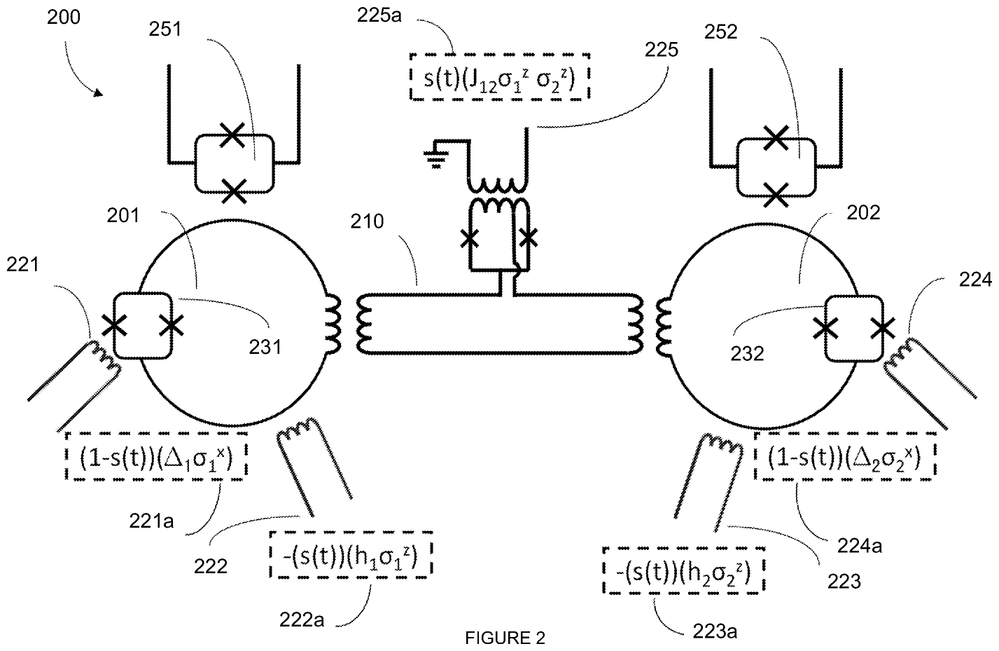

FIG. 2 is a schematic diagram of a portion of an exemplary superconducting quantum processor 200, according to at least one implementation. Superconducting quantum processor 200 may be implemented within computing system 100 of FIG. 1, forming all or part of quantum processor 126. The portion of superconducting quantum processor 200 shown in FIG. 2 includes two superconducting qubits 201, and 202. Also shown is a tunable coupling (diagonal coupling) via coupler 210 between qubits 201 and 202 (i.e., providing 2-local interaction). While the portion of quantum processor 200 shown in FIG. 2 includes only two qubits 201, 202 and one coupler 210, those of skill in the art will appreciate that quantum processor 200 may include any number of qubits and any number of couplers coupling information between them.

Quantum processor 200 includes a plurality of interfaces 221-225 that are used to configure and control the state of quantum processor 200. Each of interfaces 221-225 may be realized by a respective inductive coupling structure, as illustrated, as part of a programming subsystem and/or an evolution subsystem. Alternatively, or in addition, interfaces 221-225 may be realized by a galvanic coupling structure. In some implementations, one or more of interfaces 221-225 may be driven by one or more DACs. Such a programming subsystem and/or evolution subsystem may be separate from quantum processor 200, or may be included locally (i.e., on-chip with quantum processor 200).

In the operation of quantum processor 200, interfaces 221 and 224 may each be used to couple a flux signal into a respective compound Josephson junction 231 and 232 of qubits 201 and 202, thereby realizing a tunable tunneling term (the Δᵢ term) in the system Hamiltonian. This coupling provides the off-diagonal 6x terms of the Hamiltonian and these flux signals are examples of “delocalization signals”. Examples of Hamiltonians (and their terms) used in quantum computing are described in greater detail in, for example, U.S. Patent Application Publication No. 2014/0344322.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{Z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal σᵢ^{z}σⱼ^{z} terms in the system Hamiltonian.

In FIG. 2, the contribution of each of interfaces 221-225 to the system Hamiltonian is indicated in boxes 221a-225a, respectively. As shown, in the example of FIG. 2, the boxes 221a-225a are elements of time-varying Hamiltonians for quantum annealing and/or adiabatic quantum computing.

While FIG. 2 illustrates only two physical qubits 201, 202, one coupler 210, and two readout devices 251, 252, a quantum processor (e.g., processor 200) may employ any number of qubits, couplers, and/or readout devices, including a larger number (e.g., hundreds, thousands or more) of qubits, couplers and/or readout devices. Examples of superconducting qubits include superconducting flux qubits, superconducting charge qubits, and the like. In a superconducting flux qubit, the Josephson energy dominates or is equal to the charging energy. In a charge qubit this is reversed. Examples of flux qubits that may be used include radio frequency superconducting quantum interference devices, which include a superconducting loop interrupted by one Josephson junction, persistent current qubits, which include a superconducting loop interrupted by three Josephson junctions, and the like.

### Constrained Quadratic Problems

Quadratic functions refer to polynomial functions with one or more variables that have at most second-degree interactions. Many real-world problems can be expressed as a combination of a quadratic function to be optimized and a number of constraints placed on the feasible outcomes for the variables. In other words, a quadratic function (also referred to herein as an objective function) defines interactions between the variables, subject to a constraint or set of constraints. In order to obtain optimal or near-optimal solutions to a given problem, the objective function can be minimized or maximized, subject to the constraints on feasible results. In the example implementations described below, the problems are structured such that minimization or lower energies correspond with improved solutions. However, it will be understood that minimization problems may alternatively be structured as maximization problems (for example by reversing the sign of the function), and that the principles below apply generally to situations where an objective function is extremized. While minimization is discussed for clarity below, it will be understood that similar principles could be applied to functions that are maximized, and the term “extremized” could be substituted for “minimized”, and the energy penalties described below would be applied to penalize directions away from improved solutions.

One method of addressing constraints when solving an optimization problem is to convert the constraints to part of the objective function using penalty terms, and in the case of inequalities, additional “slack” variables, and then attempt to minimize over the new objective function. However, in some implementations, this may result in a high computational cost, such as long processing times, high numbers of slack variables being required, and/or significantly increased complexity of solution. The present disclosure describes systems and methods useful in improving computational efficiency when solving constrained quadratic problems. In particular, the presently described systems and methods may allow for specifying constraints without the requirement to convert them and include them in the objective function.

In order to allow some flexibility in solving, which may beneficially increase the probability of finding a global optimum, while also ensuring that constraints are satisfied by a final solution, a penalty value may be assigned to the constraints, allowing the weight that the constraints are given to be varied, such that the constraint may be violated in some circumstances (such as at the start of a simulated annealing). When adding constraints to an objective function, a penalty value for the constraint may need to be selected without any guidance as to an appropriate penalty value in the given problem. This may result in the need to solve the problem multiple times with different penalty values to find better solutions. The presently described systems and methods may also allow for selecting a penalty value without solving the problem multiple times with different penalty values, and for dynamic adjustment of the penalty value during the solving process.

The intended outcome of solving a constrained optimization problem is the optimization of some function, referred to herein as ƒ(x), subject to some inequality or equality constraints such as g_{c}(x)≤0. In a quadratic optimization problem, ƒ(x) and g_{c}(x) are functions with at most quadratic polynomial interactions. The optimization can be expressed as

$$x = arg {min}_{x} f ( x ) .$$

This may be expressed in terms of

$$f ( x ) = {\sum }_{i} {h}_{i} {x}_{i} + {\sum }_{i , j} {J}_{i j} {x}_{i} {x}_{j}$$

Subject to constraints

$$\sum {A}_{c , i} {x}_{i} + {\sum }_{i , j} {B}_{c , i j} {x}_{i} {x}_{j} + {b}_{c} = 0$$

In binary implementations having linear equality constraints, the linear constraint can be expressed as a function:

$${δ}_{c} = {\sum }_{i} {A}_{c , i} {x}_{i} + {b}_{c} = 0$$

$${δ}_{c , 0} = {δ}_{c} - {x}_{i} {A}_{c , i}$$

$${δ}_{c , 1} = {δ}_{c} + ( 1 - {x}_{i} ) {A}_{c , i}$$

$${Δ}_{E} = {\sum }_{c} ( {\vert {δ}_{c , 1} \vert}^{n} - \vert {δ}_{c , 0} {\vert}^{n} ) n = 0 , 1 , or 2$$

In order to treat this constraint as a quadratic term, the left-hand side (the violation from the desired value) can be squared (n=2). When the violations are small, particularly where violations are less than one, it may be beneficial to instead use a linear term (n=1) or a constant term (n=0) instead. As discussed in further detail below, for each proposed update to variable xᵢ, the Δ_{E} for each constraint is determined. Increased energy values penalize the solutions that produce those increased values, as the desired outcome is a minimization of the energy of the system.

In implementations having linear inequality constraints, the functions are treated similarly. However, in this case, the violation will be penalized only where the function is positive, and not if the function is negative. So, for example, for an inequality expressed as ΣᵢA_{c,i}xᵢ+b_{c}≤0, The violation will be penalized only where the error function is positive, otherwise no penalty will be applied.

In implementations having quadratic constraints, the functions may similarly be expressed by:

$${δ}_{c} = {\sum }_{i} {A}_{c , {i}^{x} i} + {\sum }_{i , j} {B}_{c , i , j} {x}_{i} {x}_{j} + {b}_{c} = 0$$

$${δ}_{c , 0} = {δ}_{c} - {x}_{i} {A}_{c , i} - {x}_{i} {\sum }_{j} {B}_{c , i , j} {x}_{j}$$

$${δ}_{c , 1} = {δ}_{c} + ( 1 - {x}_{i} ) {A}_{c , i} + ( 1 - {x}_{i} ) {\sum }_{j} {B}_{c , i , j} {x}_{j}$$

$${Δ}_{E} = {\sum }_{c} ( {\vert {δ}_{c , 1} \vert}^{n} - {\vert {δ}_{c , 0} \vert}^{n} ) n = 0 , 1 , or 2$$

As above, the value of n may be selected based on the value of the violation. Inequality constraints may be penalized only for a given range of values, as discussed in further detail below.

FIG. 3 is a flow diagram of an example method 300 for performing sampling in an optimization algorithm as executed on a processor-based system. Method 300 may be executed on a hybrid computing system comprising at least one digital or classical processor and a quantum processor, for example hybrid computing system 100 of FIG. 1, or by a classical computing system comprising at least one digital or classical processor. An example implementation of method 300 is discussed in further detail below with reference to a constrained binary problem.

Method 300 comprises acts 302 to 322; however, a person skilled in the art will understand that the number of acts illustrated is an example, and, in some implementations, certain acts may be omitted, further acts may be added, and/or the order of the acts may be changed.

Method 300 starts at 302, for example in response to a call or invocation from another routine.

At 302, the processor receives a problem definition having a set of variables, an objective function defined over the set of variables, and one or more constraint functions, each of the constraint functions defined by at least one variable of the set of variables.

The problem definition may be expressed as: Minimize:

Σᵢaᵢxᵢ+Σ_{i≤j}bᵢⱼxᵢxⱼ+c

Subject to:

Σᵢaᵢ^{(c)}xᵢ+Σ_{i≤j}bᵢⱼ^{(c)}xᵢxⱼ+c^{(c)}≤0,c=1, . . . ,C_{ineq} and

Σᵢaᵢ^{(d)}xᵢ+Σ_{i≤j}bᵢⱼ^{(d)}xᵢxⱼ+c^{(d)}=0,d=1, . . . ,C_{eq},

Where {xᵢ}_{1=1, . . . ,N} represents the set of variables, the sets aᵢ, bᵢⱼ, and c are real values, and C_{ineq} and C_{eq} are the number of inequality and equality constraints, respectively.

At 304, the processor receives sample values for the set of variables and a value for a progress parameter. In some implementations, the progress parameter may be an inverse temperature. The sample values may be a predetermined starting value based on known properties of the problem, may be provided by another routine, may be randomly selected, or may be provided using other techniques as are known in the art.

At 306, the processor selects an i^{th} variable from the set of variables. This may, for example, be a first variable in the set of variables on a first iteration, a second variable in the set of variables on a second iteration, etc., until all of the variables within the set of variables have been selected. In other implementations, the order of the variables may be randomized or selected according to other metrics as are known in the art.

At 308, the processor determines a variable type for the variable. The variable type may be, for example, one of binary, discrete, integer, and continuous. It will be understood that for a given problem definition, all of the variables in the set of variables may be a single type, or the problem may have a mixture of different types of variables.

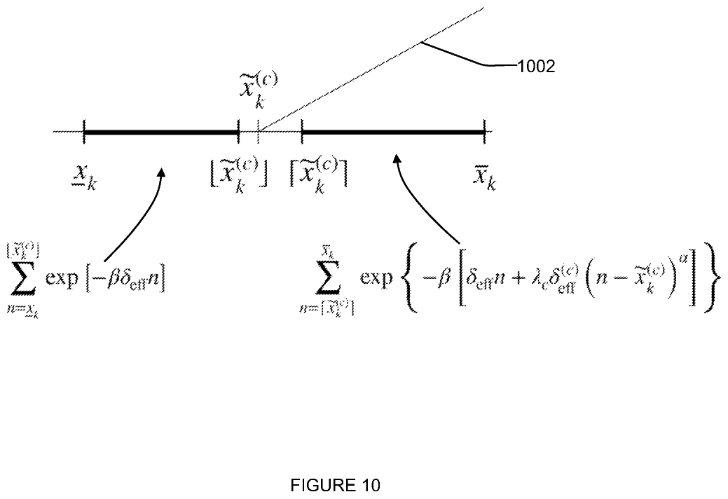

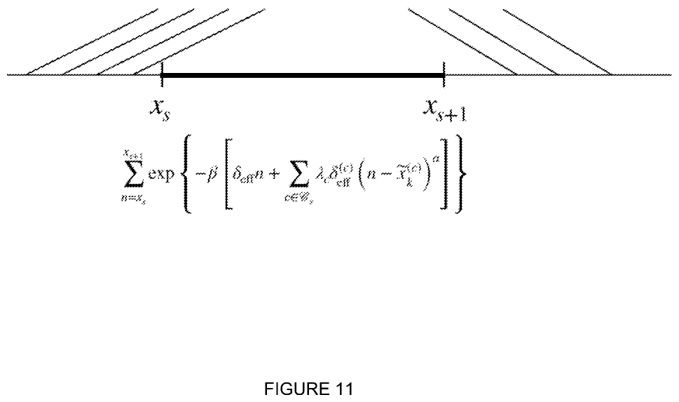

At 310, the processor selects a sampling distribution based on the variable type. In some implementations, where the variable type is binary, the sampling distribution selected may be the Bernoulli distribution. In other implementations, where the variable type is discrete, the sampling distribution selected may be the SoftMax distribution. Alternatively, in some implementations, discrete variables may be included as binary variables using one-hot constraints and the sampling distribution may be the Bernoulli distribution. One-hot constraints refers to the transformation of categorical variables into binary variables by assigning a 0/1 or True/False dummy binary variable to each category. For example, discrete variables may be added as Σ_{i∈D}xᵢ=1. In other implementations, where the variable type is integer, sampling may be performed by Gibbs sampling, that is, sampling on the conditional probability given the current state, as discussed in further detail below with reference to FIGS. 10 and 11. Alternatively, Gibbs sampling may be performed on all variable types, with the conditional probability function being determined by the variable type. It will be understood that in some implementations, integer variables may also be transformed to binary variables and sampling from the Bernoulli distribution may be performed. In some implementations, where the variable type is continuous, sampling on the conditional probability may be done by slice sampling, or the sampling distribution may be provided by a linear programming model, as discussed below in further detail.

At 312, the processor determines an objective energy bias acting on the variable under consideration given the current values of all of the other variables. As discussed above, an optimization problem may be structured with an objective function that defines an energy, and during optimization a processor returns solutions with the goal of reducing this energy. In some implementations, such as where the variable under consideration is a binary variable, an objective energy change (Δ_{E}_{ᵢ}) may be determined based on the energy of the previous solution and the energy of the current sample value, with a decrease in energy suggesting an improved solution.

At 314, the processor determines a constraint energy bias acting on the variable under consideration given the current values of all of the other variables and each of the constraint functions that involves the variable. A constraint energy bias may be defined by Δ_{E} E_{c}(|β_{c,1}|ⁿ−|β_{c,0}|ⁿ) for binary variables, as discussed above. The penalty applied to each constraint may be determined by the magnitude of the violation.

In some implementations, the processor determines a total energy change based on the objective energy change and the constraint energy change. The constraint functions are indirectly included in this energy by the processor by the addition of an energy term considering the constraints, such as in the function Δ_{E}_{ᵢ}_{,total}=Δ_{E}_{ᵢ}_{,objective}+λ (δ_{c,1}²θ(δ_{c,1})−S_{c,0}²θ(δ_{c,0})) for binary variables, as discussed above.

At 318, the processor samples an updated value for the variable from the sampling distribution based on the objective and constraint energy biases and the progress parameter. For example, in some implementations, the processor may sample from a distribution such that where the sample value was an improvement in energy and did not violate any constraint functions, the sample value is accepted, while if the sample value was not an improvement in energy and/or violated a constraint function, the sample value is only accepted with some probability that depends on the progress parameter, and otherwise a previous value is accepted. The progress parameter may allow for more violations at an early stage and fewer violations at a later stage. In other implementations, the sampled updated value may be sampled from a weighted distribution based on the total energy change and the progress parameter. For example, where the variable is a binary variable, the sampling distribution may be the Bernoulli distribution, and the variable may be sampled according to

$${x}_{i} \sim B ( 1 / ( 1 + {e}^{- β {Δ}_{{E}_{i}}} ) ) ,$$

where Δ_{E}_{ᵢ} is the total energy change, and β is the progress parameter (e.g., the inverse temperature).

In other implementations, where Gibbs sampling is performed on binary variables, the conditional partition function is used. For binary variables, the conditional probability that a variable xₖ=1 is given by p(xₖ=1)=Z_{β}(k)⁻¹e^{-βƒ(x}^{ₖ}^{=1|{x}^{ᵢ}^{}}^{_{i≠k}}⁾, where β is the progress parameter. The conditional partition function for the objective function is therefore given by Z_{β}(k)=e^{-βƒ(x}^{ₖ}^{=1|{x}^{ᵢ}^{}}^{_{i≠k}}⁾+e^{-βƒ(x}^{ₖ}^{=0|{x}^{ᵢ}^{}}^{_{i≠k}}⁾. For the objective function, the objective energy bias is given by δ_{eƒƒ}=aₖ+Σ_{i≠k}bᵢₖxᵢ, and the probability function is given by

$$p ( {x}_{k} = 1 ) = \frac{1}{1 + {e}^{β {δ}_{eff}}} .$$

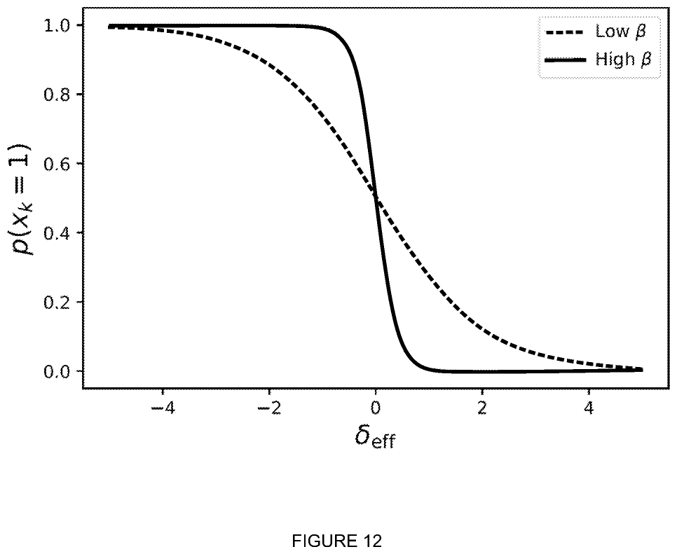

An example probability distribution based on different progress parameters is shown in FIG. 12. For the adjacent constraints, the partition function can be written as:

Z_{β}(k)=const{exp[−β(δ_{eƒƒ}+λ_{c}(δ₁^{(c)}−δ₀^{(c)})]+1},

Where const is a constant prefactor and the probability is given by

$$p ( {x}_{k} = 1 ) = \frac{1}{1 + {e}^{β ( {δ}_{e f f} + {λ}_{c} ( {δ}_{1}^{( c )} - {δ}_{0}^{( c )} )}} .$$

For discrete variables, Gibbs sampling may be performed based on the use of the one-hot constraints. Based on the expression const+Σ_{d∈D}_{ₖ}δ_{eƒƒ}^{d}xₖ^{d}, where d is the case index, Dₖ is the set of cases for variable k, the partition function can be given as

$${Z}_{β} ( k ) = {\sum }_{d ∈ {D}_{k}} {e}^{- β {δ}_{eff}^{d}} .$$

Gibbs sampling may then be performed based on the values in different segments.

For integer variables, the partition function can be given by

$${Z}_{β} ( k ) = ( {e}^{- β {δ}_{eff} {\underline{x}}_{k}} - {e}^{- β {δ}_{eff} ( {\overline{x}}_{k} + 1 )} ) {( 1 - {e}^{- β {δ}_{eff}} )}^{- 1} ,$$

where xₖ is the lower bound on variable xₖ and x̅ₖ is the upper bound. As discussed in further detail below, when considering constraints for integer values, the binding values x̅ₖ^{(c)}, which are the values at which both sides of an inequality are equal, are determined, and the partition function for each segment is given by Zₙ₌ₓ_{ₛ}^{x}^{ₛ₊}1exp {−β[δ_{eƒƒ}n+Σ_{c∈C}λ_{c}δ_{eƒƒ}^{(c)}(n−\tilde{x}ₖ^{(c)})a[}. λ_{c} is a penalty term for each constraint, used to penalize infeasible solutions. Penalty terms are discussed in further detail below. α is the penalization norm parameter, also discussed in further detail below. At 320, the processor evaluates if all of the variables of the set of variables have been considered. For example, where n variables are in the set of variables, and the processor starts with x_{]}, then xₛ, etc., the processor may monitor an incremental value between 1 and n, and when xn is considered, the incremental value may be n, and the processor will evaluate that all of the variables of the set of variables have been considered. For continuous variables, sampling may be performed from a linear programming model or a slice sampling model, as discussed in further detail below. In some implementations, sampling may be performed first for other variable types as a first subset, and then performed for the continuous variables as a second subset. If all of the variables have not been considered, control passes back to act 306, and the next variable is selected. Once all of the variables have been considered, control passes to act 322. At 322, the processor returns an updated sample with the updated value for each variable of the set of variables. Method 300 may then terminate until it is, for example, invoked again, or method 300 may repeat with new sample values from act 304. The sample output at 322 may be passed to another algorithm for further processing or may be returned as a solution to the problem. In some implementations, method 300 may be applied after a simulated annealing algorithm returns a solution, with method 300 being applied at 0 temperature, resulting in the system relaxing to the closest local minima.

In some implementations, method 300 may include receiving a value for a penalty parameter, and the total energy change may also depend on the value for the penalty parameter. Penalty parameters are discussed in further detail below. In some implementations, the penalty parameter may be a Lagrange parameter that depends on the value for the progress parameter.

An example pseudocode for method 300 in an example implementation with only binary variables is as follows: Initialization;

| δ_{c} = ΣᵢA_{c,i}xᵢ + Σ_{i,j}B_{c,i,j}xᵢxⱼ; | | |
|---|---|---|
| for i in variables do | | |
| \| | Δ_{E}^{ᵢ} = 0; | |
| \| | for c in neighborhood(i) do | |
| \| | \| | δ_{c,0} = δ_{c} − xᵢA_{c,i} − ΣⱼxᵢxⱼB_{c,i,j}; |
| \| | \| | δ_{c,1} = δ_{c} + A_{c,i}(1 − xᵢ) + (1 − xᵢ) ΣⱼxⱼB_{c,i,j}; |
| \| | \| | Δ_{E}^{ᵢ} = Δ_{E}^{ᵢ} + δ_{c,1}²Θ(δ_{c,1}) − δ_{c,0}²Θ(δ_{c,0}); |
| \| | end | |
| \| | xᵢ~B(1/(1 + e ^{-βΔE}^{ᵢ})); | |
| end | | |

As discussed above, the progress parameter may be an inverse temperature β. In some implementations, the inverse temperature may be incremented through a set range, such as starting at 0.1 and incrementing to 1. In other implementations, it may be beneficial to set the initial temperature (the highest temperature of the simulated annealing algorithm and therefore the smallest inverse temperature), βₘᵢₙ, and the final temperature (the lowest temperature of the simulated annealing algorithm), βₘₐₓ, based on the probability of moving away from a local minimal. That is, the starting and ending temperatures should be selected to be sufficiently high that there is a significant probability of moving toward a less desirable solution. In some implementations, the solutions returned by a processor may be sensitive to the initial temperature, and determining an initial temperature based on the specific problem may beneficially return improved solutions.

In some implementations, the energy bias contributed by the objective function and any constraints may be used to determine an initial inverse temperature parameter that provides a significant probability (for example a 50% probability) of sampling a value that is not locally optimal. At a high temperature during the beginning of the algorithm, this probability may be selected to guarantee that even for variables having the strongest possible energy bias, the most unfavorable values still have a relatively large probability of being sampled. At a low temperature at the end of the algorithm, the probability may be selected to guarantee that even for a variable with the smallest possible energy bias there is at least a relatively small probability of sampling the least favorable value. In other words, throughout the algorithm the probability of selecting unfavorable values starts at a predetermined relatively high probability, and then decreases, but is always non-zero.

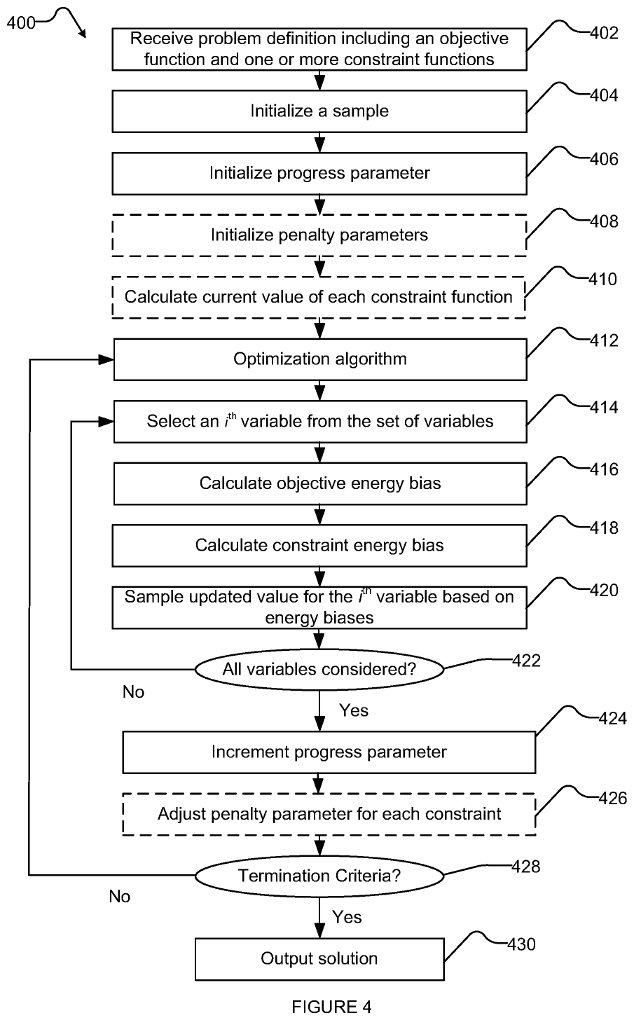

FIG. 4 is a flow diagram of an example method 400 of operation of a computing system for finding a solution to an optimization problem or other problem that may be expressed as a constrained quadratic model, or for generating sample solutions that may be used as inputs to other algorithms. Method 400 may be executed on a hybrid computing system comprising at least one digital or classical processor and a quantum processor, for example hybrid computing system 100 of FIG. 1, or by a classical computing system comprising at least one digital or classical processor. Method 400 may be used in implementations with binary variables, or method 400 may include one or more additional acts to express other variable types as binary variables.

Method 400 comprises acts 402 to 430; however, a person skilled in the art will understand that the number of acts illustrated is an example, and, in some implementations, certain acts may be omitted, further acts may be added, and/or the order of the acts may be changed.

Method 400 starts at 402, for example in response to a call or invocation from another routine or in response to an input by a user.

At 402, the processor receives a problem definition. The problem definition includes a set of variables, an objective function defined over the set of variables, and one or more constraint functions, each of the constraint functions defined by at least one variable of the set of variables. The problem definition may be received from a user (e.g., entered via an input device), transmitted from another processor, retrieved from memory, or provided as the output of another process performed by the processor. The objective function may be a quadratic function, and the problem definition may define a quadratic optimization problem. The set of variables may contain one or more of continuous, discrete, binary, and integer variables. The constraint functions may include one or more quadratic equality or inequality constraint functions.

At 404, the processor initializes a sample solution to the objective function. The sample solution may a random solution to the objective function. The random solution may be randomly selected from across the entire variable space, or the random solution may be selected within a limited range of the variable space based on known properties of the problem definition or other information. The sample solution may also be generated by another algorithm or provided as input by a user.

At 406, the processor initializes a progress parameter. The progress parameter may be a set of incrementally changing values that define an optimization algorithm. For example, the progress parameter may be an inverse temperature, and the inverse temperature may increment from an initial high temperature to a final low temperature. In some implementations, an inverse temperature is provided as a progress parameter for a simulated annealing algorithm. The selection of an inverse temperature is described in further detail above.

At 408, the processor optionally initializes a penalty parameter. In some implementations the penalty parameter may be a Lagrange multiplier as discussed in further detail below. In other implementations the penalty parameter may be selected as a constant value or a value that depends on one or more other variables.

At 410, the processor optionally calculates a current value of each constraint function at the sample values. For example, constraint functions may be given as ΣA_{c,i}xᵢ+b_{c}=0, or as inequalities, depending on the constraints provided.

At 412, the processor increments a stage of the optimization algorithm, such as by providing the progress parameter to the optimization algorithm. Optimization algorithms may include simulated annealing, parallel tempering, Markov Chain Monte Carlo techniques, branch and bound algorithms, and greedy algorithms, which may be performed by a classical computer. Optimization algorithms may also include algorithms performed by a quantum computer, such as quantum annealing, quantum approximate optimization algorithm (QAOA) or other noisy intermediate-scale quantum (NISQ) algorithms, quantum implemented fault-tolerant optimization methods, or other quantum optimization algorithms. Quantum computers may include quantum annealing processors or gate model based processors. Examples of some implementations of optimization algorithms are described in U.S. provisional patent application No. 62/951,749 and U.S. patent application publication number 2020/0234172. On successive iterations the incremented optimization algorithm may provide samples.

At 414, the processor selects an i^{th} variable from the set of variables. This may, for example, be a first variable in the set of variables on a first iteration, a second variable in the set of variables on a second iteration, etc., until all of the variables within the set of variables have been selected. The i^{th} variable has a current value from the sample initialized at act 404. In some implementations the i^{th} variable may also have an alternative value. The alternative value may be provided at act 412 by the optimization algorithm or may be generated based on known properties of the it^{h} variable. For example, if the i^{th} variable is binary, and the current value for the i^{th} variable is 0, then the alternative value for the i^{th} variable will be 1.

At 416, the processor calculates an energy bias provided by the objective function based on the current value of the i^{th} variable. In implementations with alternative values, such as where the variable is binary, this may include calculating the difference in energy for the objective function between the current value of the i^{th} variable and the alternative value for the it^{h} variable. As discussed above, an objective energy change (Δ_{E}_{ᵢ}) for binary variables may be determined based on the objective function evaluated for the i^{th} variable taking the current value and the objective function evaluated for the i^{th} variable taking the alternative value.

At 418, the processor calculates an energy bias provided by the constraints that involve the i^{th} variable. There may be one or more constraint functions that contribute to the constraint energy vias. In implementations with alternative values, this may include calculating the difference in energy for each constraint function defined by the it^{h} variable between the current value of the i^{th} variable and the alternative value for the i^{h} variable. Calculating the difference in energy for each constraint function defined by the i^{th} variable may include penalizing each constraint function by its respective penalty parameter. For example, in the case of a binary variable with a linear equality constraint, the difference in energy for the constraint function may be given as δ_{c,0}=δ_{c}−xᵢA_{c,i} and δ_{c,1}=δ_{c}(1-xᵢ)A_{c,i}, with a difference in energy given by Δ_{E}−Σ_{c} (|δ_{c,1}|ⁿ−δ_{c,0}|ⁿ), as discussed above.

At 420, the processor samples a value for the i^{th} variable based on the objective and constraint energy biases. In implementations with alternative values, this may include sampling based on the difference in energy values for the objective function and each constraint function defined by the i^{th} variable, as calculated at acts 416 and 418. As discussed above, the sampled value may be sampled from a weighted distribution based on the total energy change and the progress parameter, such as the Bernoulli distribution for a binary variable, the SoftMax distribution for a discrete variable, the conditional probability distribution for an integer variable, or a linear programming or slice sampling model for a continuous variable.

At 422, the processor evaluates if all of the variables of the set of variables have been considered. If all of the variables have not been considered, control passes back to act 414, and the next variable is selected. Once all of the variables have been considered, control passes to act 424. In some implementations, the processor may incrementally consider each variable in turn of the set of variables and evaluate that all of the variables of the set of variables have been considered when the last variable of the set of variables has been considered.

At 424, the processor increments the progress parameter. For example, if the progress parameter is an inverse temperature, and was initialized at to at act 406, the progress parameter may be incremented to t₁ during a first iteration at 424. In some implementations, t₁ may be a temperature that is lower than to. On successive iterations, the temperature may be further decreased until a final temperature is reached.

At 426, optionally, the penalty parameter for each constraint may be adjusted. In some implementations the penalty parameter may be adjusted based on the change in energy for the constraint function defined by the i^{th} variable and the progress parameter. In other implementations, the penalty parameter may be adjusted as described in methods 800 and 900, discussed in further detail below.

At 428, the processor evaluates one or more termination criteria. In some implementations, the termination criteria may be a value of the progress parameter. In other implementations, the termination criteria may include a number of iterations, an amount of time, a threshold average change in energy between updates, a measure of the quality of the current values for the variables, or other metrics as are known in the art. If the termination criteria are not met, the method continues with act 412. Acts 412-428 are repeated iteratively until the termination criteria is met. In some implementations, the set of variables sampled at act 420 may be received as input by the optimization algorithm at act 412, and the samples may be modified by the optimization algorithm before passing to act 414. As discussed above, incrementing a stage of an optimization algorithm for the objective function may include incrementing a simulated annealing or parallel tempering algorithm. In other implementations the optimization algorithm may be a MCMC algorithm or a greedy algorithm. Other optimization algorithms include branch and bound algorithms, quantum annealing, quantum approximate optimization algorithm (QAOA) or other noisy intermediate-scale quantum (NISQ) algorithms, quantum implemented fault-tolerant optimization methods, or other quantum optimization algorithms.

If the one or more termination criteria has been met, control passes to 430, where a solution is output. At 430, method 400 terminates, until it is, for example, invoked again. The solution output at act 430 may be passed to other algorithms, such as a quantum annealing algorithm.

In some implementations, after outputting a solution at act 430, method 400 may begin again with a new sample being initialized at act 404. In some implementations, method 400 may be performed multiple times in parallel starting from different initialized samples or a series of randomly generated samples. In some implementations, the solutions may be paired, and binary problems may be built to evaluate the series of solutions using Cross-Boltzmann updates as described in U.S. provisional patent application No. 62/951,749.

The methods described herein use optimization algorithms, and may, in some implementations, use simulated annealing to provide candidate solutions. Simulated annealing probabilistically decides to accept a candidate solution based both on the change in energy of the candidate solution and the stage in the simulated annealing. At early stages of the simulated annealing, candidate solutions that do not provide lower energies are more likely to be accepted, while at later stages of the simulated annealing, candidate solutions that do not provide lower energies are more likely to be rejected. This may be thought of as evolving a system from a high temperature to a low temperature. The probability of accepting a candidate solution will depend on a probability acceptance function that depends both on the energies of the current solution and the candidate solution and a time varying parameter, often represented or referred to as temperature. Another alternative is parallel tempering (also referred to as replica exchange Markov chain Monte Carlo). Similar to simulated annealing, parallel tempering begins at random initial solutions, and exchanges candidate solutions based on temperature and energies. Other optimization algorithms include MCMC algorithms, greedy algorithms, branch and bound algorithms, quantum annealing, quantum approximate optimization algorithm (QAOA) or other noisy intermediate-scale quantum (NISQ) algorithms, quantum implemented fault-tolerant optimization methods, or other quantum optimization algorithms.

The methods described herein allow a solver to implicitly consider constraint functions and penalize violations without the requirement to convert constraint functions to part of the objective function and determine appropriate penalty values. The method considers the interaction of each variable with all connected variables, and in addition, the method considers the interaction of each variable with each constraint. The method may also adjust the strength of penalties within the function until each constraint is satisfied. For each variable, the methods may perform an update specific to the variable type to allow different types of variables to be included.

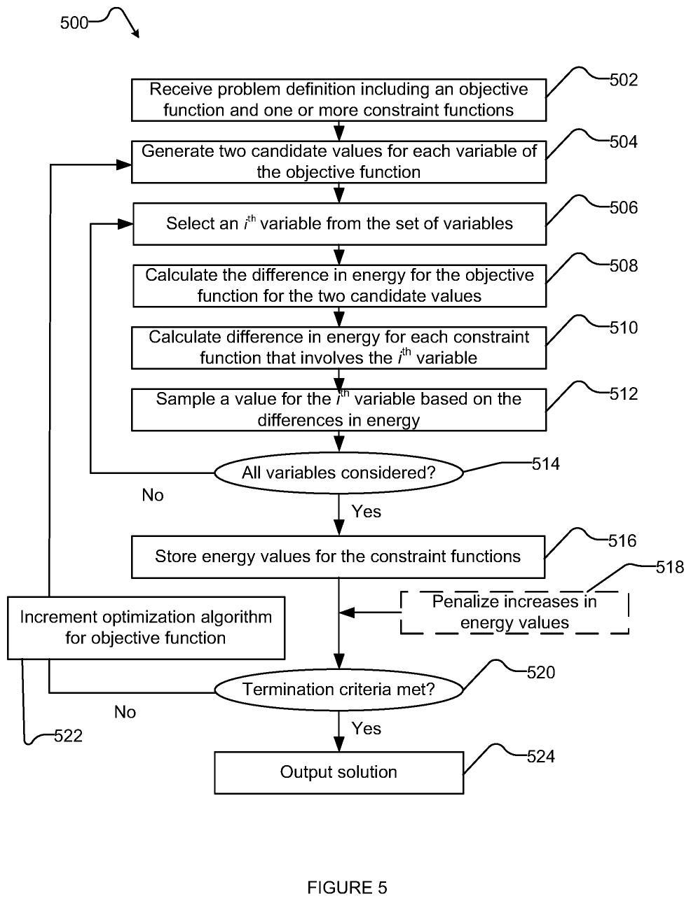

FIG. 5 is a flow diagram of an example method 500 of operation of a computing system for finding a solution to an optimization problem or other problem that may be expressed as a constrained quadratic model and having binary variables. It will be understood that similar principles may be applied to other types of variables discussed herein, either by converting the other variable types to binary variables, or by addressing the energy biases and sampling distributions as discussed in other methods herein. Method 500 may be executed on a hybrid computing system comprising at least one digital or classical processor and a quantum processor, for example hybrid computing system 100 of FIG. 1, or by a classical computing system comprising at least one digital or classical processor.

Method 500 comprises acts 502 to 524; however, a person skilled in the art will understand that the number of acts illustrated is an example, and, in some implementations, certain acts may be omitted, further acts may be added, and/or the order of the acts may be changed.

Method 500 starts at 502, for example in response to a call or invocation from another routine.

At 502, the processor receives a problem definition. The problem definition includes a set of variables, an objective function defined over the set of variables, and one or more constraint functions, each of the constraint functions defined by at least one variable of the set of variables. The problem definition may be received from a user (e.g., via an input device), transmitted from another processor, retrieved from memory, or provided as the output of another process performed by the processor. The objective function may be a quadratic function, and the problem definition may define a quadratic optimization problem. The set of variables may contain one or more of continuous, discrete, binary, and integer variables.

At 504, the processor generates two candidate values for each variable of the objective function. Example methods for generating candidate values are described in U.S. provisional patent application No. 62/951,749. The candidate values may be generated by an optimization algorithm, may be randomly generated, or a random solution may be selected, and alternative values based on the random solution may be generated. A solution may be randomly selected from across the entire variable space or may be selected within a range of the variable space based on known properties of the problem definition or other information. For example, if the i^{th} variable is binary, and the current value for the i^{th} variable is 0, then the alternative value for the i^{th} variable will be 1. For non-binary variables, an alternative value may be generated by sampling from a known distribution. In some implementations the processor may use a native sampler, such as a Gibbs sampler, in the space of integer or continuous variables to select the alternative values. It will be understood that alternative values may be generated by a variety of algorithms and may depend on the variable type and known parameters of the problem.

At 506, the processor selects an i^{th} variable from the set of variables. This may, for example, be a first variable in the set of variables on a first iteration, a second variable in the set of variables on a second iteration, etc., until all of the variables within the set of variables have been selected.

At 508, the processor calculates the difference in energy for the objective function based on the two candidate values for the i^{th} variable generated at 504. An objective energy change (Δ_{E}_{ᵢ}) may be determined based on the objective function evaluated for the fh variable at each of the candidate values.

At 510, the processor calculates the difference in energy for each constraint function between the two candidate values for the i^{th} variable. In some implementations, the difference in energy may be given by Δ_{E}−Σ_{c} (|δ_{c,1}|ⁿ−δ_{c,0}|ⁿ), as discussed above.

At 512, the processor samples a value for the i^{th} variable based on the difference in energy values for the objective function and each constraint function defined by the i^{th} variable. As discussed above, the sampled value may be sampled from a weighted distribution based on the total energy change and the progress parameter, such as the Bernoulli distribution for a binary variable.

At 514, the processor evaluates if all of the variables of the set of variables have been considered. In some implementations, the processor may incrementally consider each variable of the set of variables in turn and evaluate that all of the variables of the set of variables have been considered when the last variable of the set of variables has been considered. If all of the variables have not been considered, control passes back to act 506, and the next variable is selected. Once all of the variables have been considered, control passes to act 516.

At 516, the processor stores energy values for each constraint function based on the sampled values.

At 518, the processor optionally adjusts a penalty value applied to the energy calculation for the change in energy values for the constraint function. As discussed in further detail below, where a constraint is not satisfied, the penalty value may be increased, while where a constraint is satisfied, the penalty value may be decreased. Implementations of automatic adjustment of a penalty value is discussed below with respect to methods 800 and 900. In other implementations, the penalty value may be adjusted by a fixed value in response to a constraint being satisfied or violated.

At 520, the processor evaluates one or more termination criteria. Termination criteria may include a value for a progress parameter, a number of iterations, an amount of time, a threshold average change in energy between updates, a measure of the quality of the current values for the variables, or other metrics as are known in the art. If the termination criteria is not met, the method continues with act 522. Acts 504-522 are repeated iteratively until the termination criteria is met. If the termination criteria has been met, control passes to 524, where a solution is output. At 524, method 500 terminates, until it is, for example, invoked again.

At 522, the processor increments an optimization algorithm for the objective function to provide a new set of accepted values for the set of variables. The optimization algorithm may start from the sampled values from act 512 and generate an alternative solution in order to provide two candidate values for each variable. Optimization algorithms may include simulated annealing, parallel tempering, Markov Chain Monte Carlo techniques, branch and bound algorithms, and greedy algorithms, which may be performed by a classical computer. Optimization algorithms may also include algorithms performed by a quantum computer, such as quantum annealing, quantum approximate optimization algorithm (QAOA) or other noisy intermediate-scale quantum (NISQ) algorithms, quantum implemented fault−tolerant optimization methods, or other quantum optimization algorithms. Quantum computers may include quantum annealing processors or gate model based processors. Examples optimization algorithms are described in U.S. provisional patent application No. 62/951,749 and U.S. patent application publication number 2020/0234172.

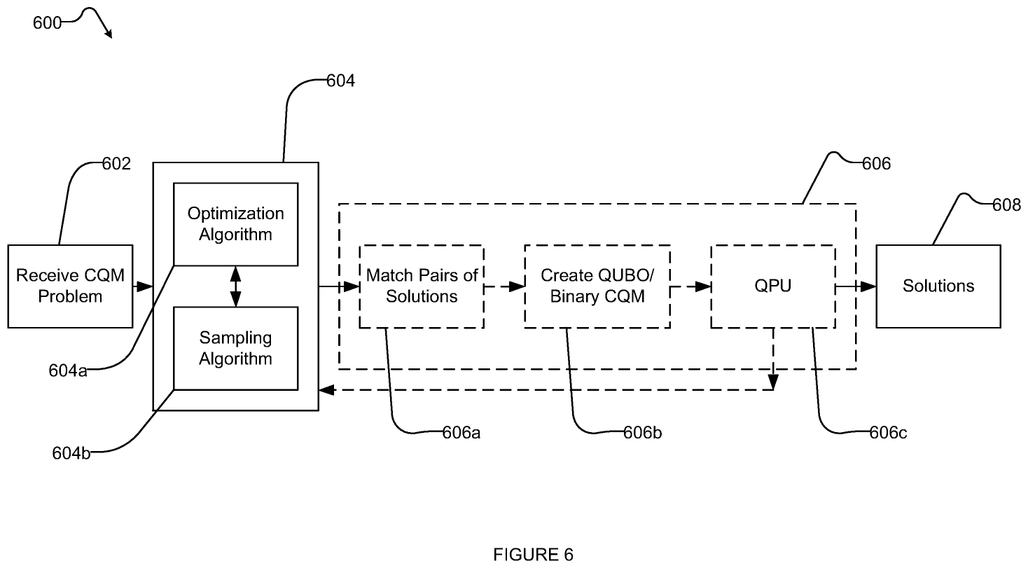

FIG. 6 is a flow diagram of an example method 600 of operation of a hybrid computing system for finding a solution to an optimization problem or other problem that may be expressed as a constrained quadratic model. Method 600 may be executed on a hybrid computing system comprising at least one digital or classical processor and a quantum processor, for example hybrid computing system 100 of FIG. 1.

Method 600 comprises acts 602 to 608; however, a person skilled in the art will understand that the number of acts illustrated is an example, and, in some implementations, certain acts may be omitted, further acts may be added, and/or the order of the acts may be changed.

Method 600 starts at 602, for example in response to a call from another routine.

At 602, the processor receives a constrained quadratic model (CQM) problem (also referred to herein as a constrained quadratic optimization problem), the constrained quadratic optimization problem having a set of variables, an objective function defined over the set of variables, one or more constraint functions, each of the constraint functions defined by at least one variable of the set of variables, and a progress parameter for the optimization, the progress parameter comprising a set of values incrementing between an initial value and a final value.

At 604, the processor generates sample solutions for the CQM problem using optimization algorithm 604a and sampling algorithm 604b. These methods may be similar to methods 300, 400, and 500 described herein. In some implementations, act 604 may include iteratively, until the final value of a progress parameter is reached: sampling a sample set of values for the set of variables from an optimization algorithm, updating the sample set of values with an update algorithm by, for each variable of the set of variables: determining an objective energy change based on the sample value for the variable and one or more terms of the objective function that include the variable, determining a constraint energy change based on the sample value for the variable and each of the constraint functions defined by the variable, determining a total energy change based on the objective energy change and the constraint energy change, determining a variable type for the variable, selecting a sampling distribution based on the variable type, and sampling an updated value for the variable from the sampling distribution based on the total energy change and the progress parameter, and then returning an updated sample, the updated sample comprising the updated value for each variable of the set of variables and incrementing the progress parameter. In other implementations, act 604 may include any other methods as described herein, for example, method 1400 of FIG. 14.

At 606, the one or more final samples generated after reaching the final value of the progress parameter, or another termination criteria as discussed above, may be transmitted to a quantum processor, and the processor may instruct the quantum processor to refine the samples. In some implementations, transmitting the one or more final samples to a quantum processor includes transmitting pairs of samples to the quantum processor (at 606a), and instructing the quantum processor to refine the samples by performing quantum annealing to select between the samples (at 606b and 606c).

At 608, the processor outputs solutions to the CQM problem. In some implementations, these solutions may be returned to a user (e.g., via an output device). In other implementations, the solutions may be passed to another algorithm for refinement, or may be returned to act 604 as a sample set of values as an input to the optimization algorithm. At 608 method 600 terminates, unless it is iterated, or until it is, for example, invoked again.

As discussed above with respect to method 600, in some implementations, the obtained samples may be further refined by a quantum computer, for example as part of a hybrid algorithm that uses cluster contractions. Cluster contraction hybrid algorithms are disclosed in more details in US Patent Application Publication No. 2020/0234172. In some implementations, the solutions may be paired, and binary problems may be built to evaluate the series of solutions using Cross-Boltzmann updates as described in U.S. provisional patent application No. 62/951,749. The initial solution may be improved by using a hybrid computing system such as hybrid computing system 100 of FIG. 1, comprising at least one classical or digital computer and a quantum computer.

In a Cross-Boltzmann update, two possible solutions may be found or provided with two different values for a given variable. A new binary variable is defined that selects between the two different values. This can then be reduced to a Quadratic Unconstrained Binary Optimization (QUBO) problem that may be optimized. In some implementations, the resulting QUBO problem may be sent to a quantum processor, and solutions may be generated using quantum annealing. A classical or digital computer may use Cross-Boltzmann updates to build a binary problem that may then be solved by the quantum computer. Cross−Boltzmann updates use the energy associated with updating two variables, both individually, and dependent on one another, to provide a Hamiltonian that expresses the decision whether to update those two variables. The digital processor may select two candidate values and may then send this update to the quantum processor as an optimization problem. A QUBO problem is defined using an upper-diagonal matrix Q, which is an N×N upper triangular matrix of real weights, and x, a vector of binary variables, to minimize the function:

$$f ( x ) = {\sum }_{i} {Q}_{i , i} {x}_{i} + {\sum }_{i < j} {Q}_{i , j} {x}_{i} {x}_{j}$$

where the diagonal terms Q_{i,j} are the linear coefficients and the nonzero off-diagonal terms are the quadratic coefficients Q_{i,j}.

This can be expressed more concisely as

$${min}_{x ∈ {\{ 0 , 1 \}}^{n}} {x}^{T} Qx .$$

In scalar notation, the objective function expressed as a QUBO is as follows:

$${E}_{qubo} ( {a}_{i} , {b}_{i , j} ; {q}_{i} ) = {\sum }_{i} {a}_{i} {q}_{i} + {\sum }_{i < j} {b}_{i , j} {q}_{i} {q}_{j}$$

### Inequalities

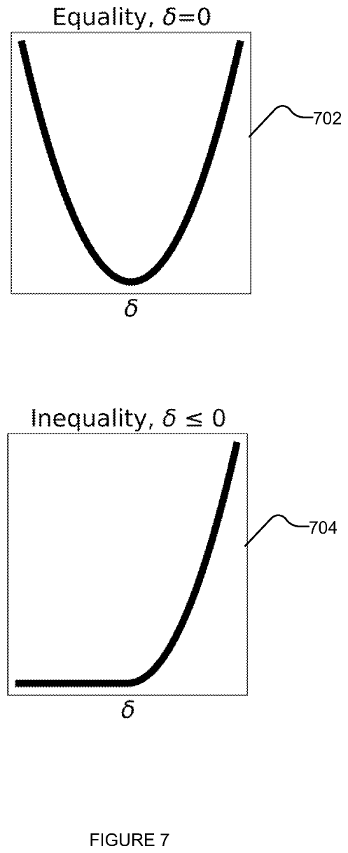

As discussed above, the contribution of the constraints to the change in energy can be represented as Δ_{E}_{ᵢ}, =Δ_{E}_{ᵢ}+δ_{c,1}²θ(δ_{c,1})-δ_{c,0}²θ(δ_{c,0}). θ(δ) is a function that addresses inequality constraints. Where an inequality constraint is not violated, θ(δ) will be zero, such that that term does not contribute to the energy. Referring to FIG. 7, θ(δ) is selected such that for equalities, the energy penalty increases away from zero, as shown in graph 702. For inequalities, θ(δ) is zero as long as the inequality is not violated, as shown in graph 704.

For example, for an inequality expressed as:

$${\sum }_{i} {A}_{c , i} {x}_{i} + {b}_{c} \leq 0$$

Penalizing the violation according to θ_{c}θ(δ_{c}), where θ(δ) is the function shown in graph 704 will only penalize the violation if the value of the constraint is positive.

### Lagrange Parameters

As discussed above, the change in energy contributed by both the objective function and the constraints can be represented as Δ_{E}_{ᵢ}, =Δ_{E}_{ᵢ}, −λδ_{c,1}²θ(δ_{c,1})−λδ_{c,0}²θ(δ_{c,0}²), where λ is a Lagrange parameter (also referred to herein as a Lagrange multiplier). The Lagrange parameter acts as a penalty parameter, with the value of the penalties assigned to each function being adjusted iteratively throughout the solution process in order to direct the search spaces toward feasibility. When a variable update returns a non-viable solution as described above, the penalty value may be increased. When a variable update returns a viable solution, the penalty may be relaxed to increase the likelihood that an optimal solution can be found.

The Lagrange multiplier may be adjusted during the optimization by evaluating the violation of the constraint functions. If a given constraint is violated, the associated Lagrange multiplier is increased. If a given constraint is satisfied, then the associated Lagrange multiplier is decreased.

As in the implementations discussed above, a CQM problem can be expressed as:

$$minimize f = {\sum }_{i} {a}_{i} {x}_{i} + {\sum }_{i , j} {b}_{i , j} {x}_{i} {x}_{j}$$

$${g}_{m} = {\sum }_{i} {a}_{i , m}^{′} + {\sum }_{i , j} {b}_{i , j , m}^{′} + {c}_{m} \leq 0 ∀ m ∈ M$$

where xᵢ, are the problem variables (which may be binary, discrete, integer, continuous, etc.) and M is set of constraints. αᵢ is the linear bias for variable i and b_{i,j} are quadratic biases between variables i and j in the objective function. Similarly, a^{i,m}′ b_{i,j,m}′ are linear and quadratic biases for constraint m.

In simulated annealing, for each variable, the magnitude of the change in the objective value is evaluated for where the simulated state of the variable changes from its current value.

$$δ {E}^{k} = {δ}_{f}^{k} + {\sum }_{m} {{μ}_{m}^{k} ( δ {v}_{m}^{k} )}^{2}$$

where δ_{ƒ}^{k} is the change in the objective value and δν_{ƒ}^{k} is the change due to violation in constraints in iteration k of the simulated annealing algorithm. μₘ^{k}, is the Lagrange multiplier for each constraint. It may be beneficial to adjust μₘ^{k} to achieve a balance between the weight given to the objective function and the weight given to the constraints in order to attempt to minimize the objective function while also satisfying the constraints. Selecting overly high values for μₘ^{k} may satisfy constraints prematurely and result in a less optimal solution to the objective function, while overly low values may result in solutions being produced that violate one or more constraints, also known as infeasible solutions.

In one implementation for updating μₘ^{k}, four metrics may be used to determine the update: i) the violation on each constraint, ii) the distance from binding for each constraint if the constraint is not violated, iii) the total violations across all of the constraints, and iv) the total distance from binding across all of the constraints. This may be represented as:

$${μ}_{m}^{k} = {μ}_{m}^{k - 1} ( 1 + \frac{{α}_{m}^{k} {v}_{m}^{k}}{\vert {\sum }_{{m}^{′}} {v}_{m}^{{k}^{2}} \vert} + \frac{{γ}_{m}^{k} {s}_{m}^{k}}{\vert {\sum }_{{m}^{′}} {s}_{m ′}^{k} \vert} )$$

where νₘ^{k} and sₘ^{k} are the violation and the distance from binding for constraint m respectively, and are calculated using:

$${v}_{m}^{k} = \{ \begin{matrix}0 if {g}_{m} ( {x}^{k} ) \leq 0 & if constraint is lower equality \\ {g}_{m} ( {x}^{k} ) if {g}_{m} ( {x}^{k} ) > 0 & if constraint is lower equality \\ \vert {g}_{m} ( {x}^{k} ) \vert & if constraint is equality\end{matrix}$$

$${s}_{m}^{k} = \{ \begin{matrix}{g}_{m}^{k} ( x ) if {g}_{m} ( {x}^{k} ) \leq 0 & if constraint is lower equality \\ 0 if {g}_{m} ( {x}^{k} ) > 0 & if constraint is lower equality \\ 0 & if contraint is equality\end{matrix}$$

aₘ^{k} and γₘ^{k} are two multipliers that are adjusted during the optimization using a global damping factor (dƒ) and a local increment method.

Global damping is used to stabilize the penalty values after finding the first feasible solution. The parameters are damped using a damp factor dƒ:

dƒ=1/\sqrt{k−r}

αₘ^{k}=αₘ^{k-1}−dƒ

γₘ^{k}=γₘ^{k-1}dƒ

where α⁰ and γ⁰ are initial adjuster values, k is the iteration number, and r is the iteration number for the first feasible solution.

A local increment method is used such that when the problem becomes infeasible and fails to improve the total violation, a₀ is increased exponentially by a constant factor (e.g., 1.2) and when the problem becomes feasible and fails to improve the current best possible solution, γ₀ is increased exponentially by a constant factor (e.g., 1.2) after t iterations defined as:

t=\sqrt{log_{scale}(βₘₐₓ/βₘᵢₙ)}

where βₘᵢₙ, βₘₐₓ and scale are simulated annealing parameters.

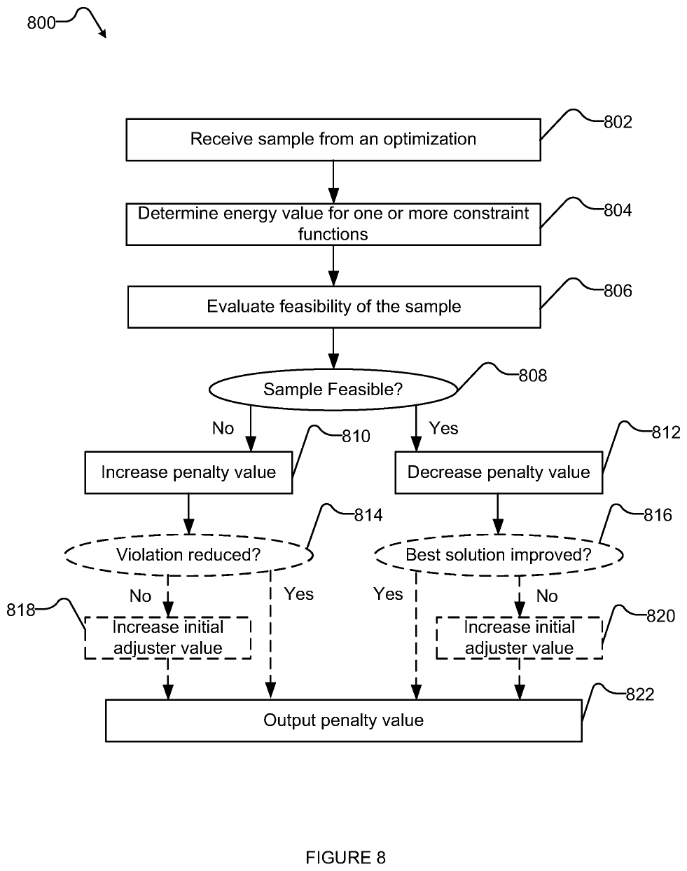

FIGS. 8 and 9 are flow diagrams of example methods 800 and 900 for adjusting penalty parameters to direct the search space toward feasibility, which may advantageously improve performance of a processor-based system executing the methods 800 and 900. Methods 800 and 900 may be implemented as subprocess of simulated annealing, or as part of an optimization algorithm. As discussed below, method 900 starts with initialization of the Lagrange initial parameters and multipliers, and in particular the initial Lagrange values u, a and γ. In addition, tinƒ and tƒ counters are initialized to count the number of iterations that the search fails to make progress in lowering infeasibility (total violations), and best feasible solution, respectively. tinƒ is the number of iterations that the search stays in in the infeasible region without lowering infeasibility (lowering total violation), while tƒ is the number of iterations that the search stays in feasible region without improving the best feasible solution. t, as discussed above, is the number of iterations that the algorithm waits before increasing a and γ.

During the update method of simulated annealing, for a given state, its current objective, and constraint left hand side energy, the system checks the feasibility of the solution, distance of constraints from binding, and their violations. Then the system adjusts the search toward feasibility or infeasibility according to improvement in best possible solution and total violations. Finally, Lagrange multipliers are adjusted based on the new value for α, γ, violation/constraints bindings and Lagrange multipliers from previous iteration.

In some implementations, the Lagrange parameters may also be varied directly with the progression of the simulated annealing along the progress parameter, such as inverse temperature. At the start of the simulated anneal, the Lagrange parameters may be smaller, and the penalty assigned to violations may be smaller. Near the end of the simulated anneal, the penalty assigned to violations may increase such that the constraints may be satisfied in the final solutions.

FIG. 8 is a flow diagram of an example method 800 for directing a search space towards feasibility in an optimization algorithm, which may advantageously improve the performance of a processor-based system in performing optimization. Method 800 may be executed on a hybrid computing system comprising at least one digital or classical processor and a quantum processor, for example hybrid computing system 100 of FIG. 1, or by a classical computing system comprising at least one digital or classical processor.

Method 800 comprises acts 802 to 822; however, a person skilled in the art will understand that the number of acts illustrated is an example, and, in some implementations, certain acts may be omitted, further acts may be added, and/or the order of the acts may be changed.

Method 800 starts at 802, for example in response to a call or invocation from another routine.

At 802, the processor receives a sample from an optimization algorithm, such as a simulated annealing algorithm as discussed above. In some implementations, method 800 may be called by any one of methods 300, 400, 500, and 600 as discussed above, or method 1400 discussed below. Method 800 may be used to adjust penalty parameters, such as at act 426 of method 400, or act 518 of method 500.

At 804, the processor determines an energy value or bias for one or more constraint functions. In some implementations, the processor may evaluate the constraint functions for the given sample. In other implementations, such as in the methods discussed above, an energy value for one or more constraint functions may be calculated by another function and passed to act 804, such as by act 418 of method 400 or act 516 of method 500.

At 806, the processor evaluates the feasibility of the sample. This may, for example, be determined by the value received for the energy value for the one or more constraint functions. In some implementations, a function may be provided, as discussed above with reference to FIG. 7, that zeros out energy values for feasible samples. Where a constraint is violated, the sample is considered to be infeasible.

At 808, control passes to 810 where the sample is not feasible, and control passes to 812 where the sample is feasible.

At 810, the processor increases the penalty value for a constraint that is violated for a non-feasible sample. In some implementations, the penalty value may be incremented by a constant value at each iteration where a non-feasible sample is returned. As only feasible samples are desired, incrementing the penalty value until the constraint functions are sufficiently weighted that the algorithm returns only feasible solutions is beneficial.

At 812, the processor decreases the penalty value for a feasible sample. As having too much weight on a constraint may result in feasible solutions that are less than optimal, the penalty value may be decreased where feasible samples are returned. As discussed below with respect to method 900, a damping factor may be used to converge the penalty value to a low value that returns feasible solutions. In some implementations, the penalty value may be decreased by a constant value at each iteration where a feasible sample is returned until a non-feasible sample is returned. The penalty value may then be increased until a feasible sample is returned, and then maintained at that penalty value for remaining iterations.

At 814, the processor optionally determines if a violation has been reduced in comparison with a previous sample. For example, this may be done by comparing constraint violation functions as discussed above. If the total energy penalty contributed by the constraint functions increases, the violation has been increased. If the total energy penalty contributed by the constraint functions decreases, the violation has been reduced. In some implementations, the violation may also remain the same, and as such has not been reduced. If the violation has been reduced, control passes to 818, otherwise to 822.

At 818, the processor increases an initial adjuster value. For example, as discussed above, a₀ may be increased exponentially by a constant factor (e.g., 1.2).

At 816, the processor optionally determines if a current best solution has been improved in comparison with a previous sample. If the current best solution has been improved, control passes to 822, otherwise to 820. For example, this may be done by comparing the energy of the objective function in the previous iteration to the energy of the objective function At 820, the processor increases an initial adjuster value. For example, as discussed above, γ₀ may be increased exponentially by a constant factor (e.g., 1.2).

At 822, the processor outputs a penalty value to be returned to the optimization algorithm. Method 800 may then terminate until it is, for example, invoked again.

FIG. 9 is a flow diagram of an example implementation of method 800 for directing a search space towards feasibility in an optimization algorithm, in the form of method 900, which may advantageously improve the performance of a processor-based system in performing optimization. FIG. 9 demonstrates how Lagrange multipliers may be automatically adjusted during a simulated annealing procedure for solving a CQM problem.

FIG. 9 illustrates the main simulated annealing procedure 902, along with acts 904-922 which illustrate a procedure for automatic adjustment of multipliers.

At 904, the system initializes the Lagrange parameters. In the example implementation of FIG. 9, the Lagrange parameter λₘ⁰, is initialized for iteration k=0 with initial adjusters a⁰ and γ⁰ set to 2 and 0.05 respectively. t represents a number of iterations that initial adjusters a⁰ and γ⁰ remain at the same value when the problem is infeasible and fails to improve the total violation, or when the problem is feasible and fails to improve the best possible solution. βₘᵢₙ, βₘₐₓ and scale are simulated annealing parameters provided by the simulated annealing algorithm. tinƒ and tƒ are counters used to count the number of iterations in the infeasible and feasible regime during which the sampling has failed to make progress and are initially set to zero.

At 906, the system receives an energy for a constraint function and a current state of a variable from an optimization or update algorithm. For example, a sample value generated by one of methods 300, 400, 500, 600, or 1400 may be passed to the system, along with an energy for a constraint function found by one of those methods. In some implementations, the system may receive an energy for a constraint function and a current state of a variable from a simulated annealing algorithm.

At 908, the system evaluates a damp factor, violations, and bindings. A damp factor may be provided as an initial parameter or may be adjusted in response to fluctuations between feasible and infeasible values in previous iterations. Violations may be evaluated from constraint functions, such as discussed above. For example, a constraint may be evaluated and multiplied by a function as discussed with respect to FIG. 7. The binding may be calculated as a distance from binding for each constraint where the constraint is not violated, and/or the total distance from binding across all constraints.

At 910, the system determines if the current sample is feasible, that is, if any of the constraints are violated. This may be determined based on the energy of the constraint, as discussed above. If one or more of the constraints are violated, the method passes to act 912, while if the sample is feasible (i.e., no constraints are violated), the method passes to 914.

At 912, the system determines if the violation has been reduced. As above, this may be determined based on the energy of the constraint. If the violation has been reduced, control passes to 916, with no change to the counter values (tinƒ and tƒ remain at zero). If the violation has not been reduced, control passes to 918.

At 918, counter tinƒ is incremented by one, and compared to t. If tinƒ is greater than or equal to t, the value of initial adjuster a⁰ is increased (for example by some constant factor, such as an exponent of 1.2). If the value of initial adjuster a⁰ is increased, tinƒ is reset to zero. Control is then passed to 916.

At 914, the system determines if the best solution has been improved, that is, if the energy of the objective function has been decreased, or a more optimal solution has been found. If the solution has been improved, control passes to 916, with no change to the counter values (tinƒ and tƒ remain at zero). If the best solution has not been improved, control passes to 920.

At 920, counter tƒ is incremented by one, and compared to t. If tƒ is greater than or equal to t, the value of initial adjuster γ⁰ is increased (for example by some constant factor, such as an exponent of 1.2). If the value of initial adjuster γ⁰ is increased, tƒ is reset to zero. Control is then passed to 916.

At 916, the system determines the effective values for aₘ^{k} and γₘ^{k} based on a dampening factor df as described above. Once a feasible solution is found, the change in parameters is damped using the damp factor, which may, for example, depend on the current iteration number and the iteration number where the first feasible solution was found (dƒ=1/\sqrt{k−r}). αₘ^{k} and γₘ^{k} may be evaluated according to aₘ^{k}=aₘ^{k-1}−dƒ and γₘ^{k}=γₘ^{k-1} dƒ.

At 922, the system generates an updated Lagrange multiplier for each constraint based on if the constraint is satisfied, and the effective values for a^{k} and γ by evaluating the equation for pₘ^{k} discussed above:

$${μ}_{m}^{k} = {μ}_{m}^{k - 1} ( 1 + \frac{{α}_{m}^{k} {v}_{m}^{k}}{\vert {\sum }_{{m}^{′}} {v}_{m}^{{k}^{2}} \vert} + \frac{{γ}_{m}^{k} {s}_{m}^{k}}{\vert {\sum }_{{m}^{′}} {s}_{{m}^{′}}^{k} \vert} ) .$$

The updated Lagrange multipliers are then passed back to 902, and may be used in other algorithms, such as being passed back to a stage of a simulated annealing algorithm.

### Example with Pseudocode

In some implementations, the problem to be solved may involve only binary variables. One example implementation of such a binary problem having binary variables xᵢ, x₂ will now be discussed. It will be understood that the example problem is representative of one possible example implementation only, and that other implementations may go beyond what is discussed below.

The processor receives a constrained quadratic model (CQM) problem having an objective function such as ƒ(x₁, x₂), and constraint functions such as g(x₁, x₂) and h(x₁). The constraint functions may include equalities or inequalities.

The processor receives or initializes a sample. The sample may be generated by another algorithm, may be received as an input, may be sampled from a distribution, or may be randomly generated. For the purposes of this example, a random sample is initialized as x̅_{random}=[0, 1]. In some implementations, a pair of samples may be received.

The processor receives or initializes a progress parameter. In some implementations, the progress parameter may be an inverse temperature. The processor may, for example, initialize an inverse temperature as t₀. For example, in some implementations, simulated annealing may be used to perform optimization. The temperature of the system may be set to some high temperature initially and may be incremented to some lower temperature. This may have the effect of allowing the acceptance of higher energy solutions at the beginning of the optimization, reducing the probability of remaining in a local minimum, and preventing the acceptance of higher energy solutions near the end of the optimization.

The processor may optionally receive or initialize penalty parameters. For example, the processor may initialize Lagrange parameters as discussed in further detail above as a function of the progress parameter and the magnitude of the energy violation, e.g., λ_{c}(t, δ_{c}).

The processor computes the current value of each constraint based on the sample that was received or initialized. In the given example of x̅_{random}=[0, 1], the processor computes g(0,1), h(0).

The processor then considers each variable in turn. The variable has a current value provided by the initialized sample, and the processor may either determine an alternative value based on properties of or restrictions on the variable or may receive an alternative value as input or from another algorithm. For example, given that x₁ is a binary variable, and the sampled value from x̅_{random} is 0, the alternative value for x₁ must be 1. It will be understood that in the case of variable types other than binary, alternative values may be received with the initial sample, or may be generated by another algorithm. The processor considers the objective function and determines the energy terms contributed by the objective function in the neighborhood of the variable. The processor also considers the constraint functions that involve the variable for the current value of the variable and the alternative value of the variable. In the given example, the processor may begin with x₁ and find the value of the linear terms of the objective function f(x₁, x₂) that involve x₁ for the initialized sample value (0) and an alternative value (1). This may include pairwise interaction terms between x₁ and x₂ and the coefficients of terms that involve only x₁. It will be understood that in larger examples there may be a variety of pairwise interaction terms between different variables. An energy value, such as Δ_{E} may then be set to the energy contributed by these terms for x₁.

For each constraint that involves x₁, an energy value for the constraint is determined by the processor based on the initially calculated constraint values g(0,1), h(0), and the pairwise terms for g(1,1), the alternative value for x₁ that involve x₁. In the given example, the constraint energy may be calculated by the processor as δ_{x1,1}=g(1,1)+h(1) and δ_{x1,0}=g(0,1)+h(0). These terms are then added to the current energy value as Δ_{E}=Δ_{Ex,1}+λ_{t0δx1,1}²θ(δ_{x1,1})−λ_{t0,δx1,0}²θ(δ_{x1,0}), where θ(δ) is a function for inequality constraints, as discussed in further detail above with reference to FIG. 7. Where an inequality constraint is not violated, O(6) will be set to zero, such that that term does not contribute to the energy.

A sample value for variable x₁ is then generated by the processor based on A_{E} and t₀. The sampling may vary depending on the type of variable, and may, for example, sample from a distribution, or generate samples in another way. In some implementations, if the sampled value does not violate any constraints, the sampled value is accepted, while if the sampled value does violate constraints, the sampled value is accepted with a probability that depends on to. This value then becomes x_{i,t0}, for example, x_{i,t0}=1.

The processor then considers x₂ and repeats the same to sample a value for x_{2,t0}.

Once all of the variables have been considered and a new sample value has been generated, the processor then increments the progress parameter. The generated sample Rₜ₀=[x_{1,t0}, x_{2,t0}] may be passed back to take the place of x̅_{random}, or some other processing operation may be performed. For example, in the case of simulated annealing, the generated sample x̅ₜ₀ may be passed back to a simulated annealing algorithm, which may sample new values starting from x̅ₜ₀, with the new values being returned to the presently discussed algorithm in the place of x̅_{random}. The processor increments over the progress parameter, generating an updated sample for each value of the progress parameter, such as from an initial inverse temperature to a final inverse temperature. The penalty parameter may also be updated at each increment of the progress parameter.

At the final inverse temperature, the generated sample x̅_{final}=[x_{1,tf}, x_{2,tf}] is returned. Sampling from an initial sample over a progress parameter may be repeated multiple times, starting from a new randomly generated x̅_{random} for each repeat in the example above from the initial to final inverse temperature. This may be done in parallel for multiple starting samples. This results in a set of samples provided by a set of X̅_{final} values.

An example pseudocode for the above discussed simple binary problem is provided below:
Receive objective function f(x₁, x₂), constraints g(x₁, x₂), h(x₁)
Initialize a sample x̅_{random}=[0, 1]
Initialize penalty parameters λ_{c}(t, δ_{c})
Initialize t=t₀

Compute current value of each constraint based on x̅_{random} to give g(0,1), h(0)

For each t:

For each variable:
For x₁:
   Determine alternative value. x₁=0, could alternatively be 1 (binary).
Δ_{E,x1}=linear bias=the terms of f(x₁, x₂) that involve x₁
Δ_{E,x1}=terms of f(1,1)−terms of f(0,1) that involve x₁

For each constraint c in neighborhood (x₁):
δ₂1,1=g(1,1)+h(1)−compute only pairwise terms that involve x₁ in g(x₁, x₂) for g(1,1).
δ_{x1,0}=g(0,1)+h(0)−g(0,1) and h(0) are already known from above.
Δ_{E}=Δ_{E,x1}+λ_{t0,δx1,1} δ_{x1,1}² θ(δ_{x1,1}−λ_{t0,δx1,0} δ_{x1,0}² θ(δ_{x1,0})

Sample a value for variable x₁ using A_{E} and t₀:
Example: Returns x_{1,t0}=1

Update δ_{c}=g(1,1)+h(1)

For x₂:
Alternative value: x₂=0.
Δ_{E},x₂=terms of f(0,1)−terms of f(0,0) that involve x₂

For each constraint c in neighborhood(x₁):
δ_{x2,0}=g(0,0)−compute only pairwise terms that involve x₂ in g(x₁, x₂) for g(0,0).
δ_{x2,1}=g(0,1)−g(0,1) is already known from above.
Δ_{E}=Δ_{E,x2}+λ_{t0,x2,0} δ_{x2,0}² θ(δx_{2,0})−λ_{t0,δx2,1}δ_{x2,1}² θ(δ_{x2,1})

Sample a value for variable x₂ using A_{E} and t₀:
Example: Returns x₂,t0=1

Update δ_{c}=g(1,1)

Increment inverse temperature−Set t=t₁.

Either pass to optimization algorithm and receive samples back or repeat for t₁ directly.

The methods and systems described herein beneficially allow for computationally efficient solving optimization problems with constraints by handling the constraints directly as opposed to converting them to part of an objective function. This may beneficially allow a processor to return feasible solutions to an optimization problem in a time efficient and scalable manner. This may also allow for the generation of multiple solutions in parallel by the processor. The contributions of the constraints may be handled implicitly through an update process that considers each constraint. Handling the constraint functions directly and pulling energy values for the constraint functions through the computations may increase the efficiency of solutions. The methods and systems described herein may also advantageously allow for automatic and dynamic adjustment of penalty weights for the constraint functions, allowing for the search to be efficiently directed toward feasibility while returning better solutions. Many real-world problems, such as those solved in industry, are problems having constraints on viable solutions. The methods and systems described herein may also allow for solution of problems having a set of variables with different types, such as a mixture of binary and discrete variables. Sampling may be done based on a determination of the variable type and considering the current energy values and penalties. In some implementations, the methods and systems described herein may be used in combination with hybrid quantum computing techniques to provide improved solutions.

### Integer Variables

As discussed above, constrained problems may be defined over different variable types, such as binary, discrete, integer, and continuous. The variable types may determine the sampling distribution selected by the processor for sampling updated values for those variables. In some implementations, where the variable type is binary, the sampling distribution selected may be the Bernoulli distribution. In other implementations, where the variable type is discrete, the sampling distribution selected may be the SoftMax distribution.

Where the variable type is integer (or continuous), there may not be a single well-defined distribution that may be selected. Many optimization problems include integer variables, and constraints on the values those integer variables may take. In order to support integer variables in a constrained problem solver as discussed above, it may be beneficial to provide “native” support for integer variables. An update for integer variables considering their constraints and Lagrangian parameters is discussed below.

One technique for implementing integer updates includes temporarily relaxing the integer variable to a continuous variable, computing the gradient due to the objective and Lagrangian relaxation of the constraints that involve that variable, proposing an update due to that gradient, and probabilistically accepting or rejecting it, similar to the process described above. However, these types of updates for integer variables may result in high algorithmic complexity (on the order of the number of adjacent constraints) where there is complexity in the constraints and/or many overlapping constraints. Alternatively, an integer variable, defined with a bounded range of size R, could be implemented similarly to a binary variable by transforming the integer variable into approximately log(R) binary variables. This could then be updated by selecting the Bernoulli distribution as the sampling distribution and proceeding with updates as described above for binary variables. However, this type of update requires a selection of the best way to transform an integer variable into a binary variable. Some examples include the base 2 representation or a Gray code. With log(R) binary variables, sampling may take exponential time, resulting in a run time on the order of R.

It may be beneficial to perform integer updates by examining the adjacent constraints for a given integer variable and dividing the range of the integer variable into a series of segments, with each segment having the same form of constraint penalty. A segment may then be randomly chosen based on the integral of the objective and constraint penalties in that segment. A new value can be sampled for the integer from within the segment. While the method below is discussed in the context of integer variables, it may also be extended for use with continuous variables as discussed below.

This process will take O(M log(M)+Mt) time, where M is the number of constraints and t is the runtime needed to compute the partition function or sample on a segment. In the case where the integer variable only has a linear term (or terms) in the objective function, t=0(1), the update described as follows would be expected to take 0(M log(M)) time. If the integer variable has a quadratic term in the objective, t is expected to be 0(log(r)), where r is the range of the segment, and in some cases may be 0(1). This is beneficially expected to be faster than the other methods discussed above, such as relaxing integer variables to continuous variables or transforming into integer variables.

When sampling values for an integer variable, Gibbs sampling may be performed, that is, sampling on the conditional probability given the current state. This is described in further detail below. As discussed above, in the context of solving a CQM problem, both the objective function and the constraint functions are considered when sampling new values. Therefore, to update a given integer variable, sampling may be performed on the conditional probability given the current state or the presently accepted values of the variables. The conditional probability of the objective function may be computed analytically as described below.

It will be understood that while quadratic functions include squared variables, some of the equations in the implementation described herein may not work for a squared integer variable. In those implementations, a new variable may be defined. For example, where an integer variable x₁ is squared in the objective function or in a constraint, a new variable x₂ may be defined, and the square may be replaced with x₁x₂, with the additional constraint x₂=x₁. It will be understood that this substitution may be required in the equations used above, such as where variables are described with indexes i and j, and for the case i=j. It will be understood that other substitutions may similarly be made to address squared variables. In other implementations, the equations below may be modified. An alternative implementation to address squared (quadratic) variables without the addition of extra variables is also discussed below using slice sampling.

The constraints are considered by computing the binding values. Assuming that the effective linear bias on the variable for a constraint adjacent to the variable is greater than zero, there are three possible outcomes: the binding value may be less than the lower bound on the variable, the binding value may be between the upper bound and the lower bound for the variable, and the binding value may be greater than the upper bound on the variable. In the case where the binding value is greater than the upper bound on the variable, the constraint is satisfied for all possible values of the variable and the partition function is given by the conditional partition function that includes only the conditional objective function. In the case where the binding value is less than the lower bound on the variable, all possible values of the variable violate the constraint and must be penalized. Where the effective linear bias on the variable is less than zero, these situations are reversed. As discussed above, a penalty may be applied as a constant or may be varied according to the magnitude of the violation and the stage of the optimization algorithm.

In the case where the binding value is between the upper and lower bounds on the variable, the domain may be divided into two segments as shown in FIG. 10. As above, FIG. 10 assumes that the effective linear bias is greater than zero. In the case where the effective linear bias is less than zero, the result will be inverted. The first segment is defined by the lower bound of the variable and the integer that is less than or equal to the binding value, and the second segment is defined by the integer that is equal to or greater than the binding value and the upper bound. The partition function may then be calculated as the sum of the partition functions of these two segments. The first segment can use the same partition function as the case where the binding value is greater than the upper bound on the variable, that is, the conditional partition function for the objective function. The second segment can use the same partition function as the case where the binding value is less than the lower bound on the variable, with the penalization applied. In the case where the effective linear bias on the variable is less than zero, the situation will be the same as above, but with the cases swapped. This may then be used to generalize to multiple constraints.

Given the functions for the objective functions and the constraints, a new value may be sampled by Gibbs sampling based on the conditional probability given the current state.

As discussed above, a constrained quadratic model (CQM) is defined by an objective function and a set of constraints. The CQM has a set of variables x₁, which may, for example, be combinations of binary, integer, discrete, and continuous variables, or other types of variables. In some implementations, one or more of the variables are integer variables. In an implementation, an objective function is defined, for example, ƒ(x)=Σᵢ aᵢxᵢ+Σ_{i<j}w_{i,j}xᵢxⱼ. A set of M constraints of the form g_{c}(x)=Σᵢ a_{i,c}xᵢ+Σ_{i<j}w_{i,j,c}xᵢxⱼ+C_{C}≤,≥,or =0 is provided. A constraint g_{c}(x) is considered to be “adjacent” for a given variable x₁ if either a_{i,c} or w_{i,j,c} for any j is non-zero. The integer variables in the CQM may be given with lower and/or upper bounds, which may be defined as lb [k] (lower bound) and ub[k] (upper bound) for a variable xₖ. The bounds may alternatively be represented as constraints.

To update a given integer variable xₖ, Gibbs sampling is performed on the conditional probability given the current state of all other variables. Considering the objective function, when updating integer variable xₖ, the conditional partition function is given by:

Z_{β}^{(k)}=Σ_{n=lb[k]}^{ub[k]}exp[−βƒ(n|{xᵢ}_{i≠k})] (1)

and the conditional objective function can be written as:

exp[−βƒ(n|{xᵢ}_{i≠k})]=exp[−βA]exp[−βδ_{eƒƒ}n],

where the constant A includes all the terms in ƒ(x) that do not involve the variable xₖ, A=ƒ(x)−δ_{eƒƒ}xₖ, and δ_{eƒƒ}is the effective linear bias of the variable xₖ, δ_{eƒƒ}=aₖ−Σ_{i≠k}wᵢₖxᵢ.

When inserted in the partition function, the first term of the right-hand side of the equation (exp[−βA]) becomes an irrelevant pre-factor and the partition function can be taken as:

$${z}_{β}^{( k )} = {\sum }_{n = l b [ k ]}^{u b [ k ]} exp [ - β {δ}_{eff} n ] .$$

In the case where δ_{eƒƒ}>0, the partition function can be computed analytically using:

$${\sum }_{n = 0}^{∞} {x}^{n} = \frac{1}{1 - x} , \vert x \vert < 1 ,$$

And yields:

Zβ(k)=(e^{-βδ}^{_{eƒƒ}}^{lb[k]}−e^{-βδ}^{_{eƒƒ}}^{(ub[k]+1)})(1−e^{-βδ}^{_{eƒƒ}})⁻¹ (2)

In the case where δ_{eƒƒ}<0, the partition function can be analytically calculated using the same series identity as above with the substitution m=−n, to give:

Zβ(k)=(e^{-β|δ}^{_{eƒƒ|}}^{lb[k]}−e^{-β|δ}^{_{eƒƒ|}}^{(ub[k]-1)})(1−e^{-β|δ}^{_{eƒƒ|}})⁻¹ (3)

Considering the constraints, all constraints are expressed as inequality constraints, with equality constraints being implemented as a combination of two inequalities, and any constraint c adjacent to a variable xₖ can be written as:

g_{c}(xₖ|{xᵢ}_{i≠k})=A^{(c)}+δ_{eƒƒ}^{(c)}xₖ≤0,

and the binding values \tilde{x}(k_{c}) can be computed such that

g_{c}(xₖ|{xᵢ}_{i≠k})=A^{(c)}+δ_{eƒƒ}^{(c)}\tilde{x}ₖ^{(c)}=0.

Where δ_{eƒƒ}^{(c)}>0, all of the valuesn>\tilde{x}ₖ^{(c)} will need to be suppressed, while if δ_{eƒƒ}^{(c)}<0, all of the values n<\tilde{x}ₖ^{(c)} will need to be suppressed. Assuming that δ_{eƒƒ}^{(c)}>0, there are three different possibilities:
1. \tilde{x}ₖ^{(c)}<lb[k],
2. lb([k]≤\tilde{x}ₖ^{(c)}≤ub[k],
3. \tilde{x}ₖ^{(c)}>ub [k]

Considering case 3, the constraint is satisfied for all possible values of xₖ and no values need to be suppressed. The conditional partition function is given by equation (1).

Considering case 1, all possible values of the variable xₖ violate the constraint and should therefore be penalized. The partition function can be written as:

$${Z}_{β}^{k} = {\sum }_{n = l b [ k ]}^{u b [ k ]} exp \{ - β [ {δ}_{eff} n + {λ}_{c} {{δ}_{eff}^{( c )} ( n - {\tilde{x}}_{k}^{( c )} )}^{α} ] \} ,$$

Where α≥0 allows the use of different penalties for violating the constraint. In some implementations, α=0, 1, or 2 may be used, corresponding respectively to L₀, L₁, and L₂ penalties as discussed above. Note that the L_{α} norm of the violation in the equation should be (δ_{eƒƒ}^{(c)}(n−\tilde{x}ₖ^{(c)}))^{α}, which would mean that L₀ would have all constraints with the same importance independent of the relative magnitude of violation of each constraint. The effective bias term δ_{eƒƒ}^{(c)} may therefore be excluded from the exponent as above.

Considering case 2, the domain of variable xₖ can be divided in two segments as shown in FIG. 10: lb [k]≤xₖ≤|\tilde{x}ₖ^{(c)}| and |\tilde{x}ₖ^{(c)}|≤xₖ≤ub[k]. In FIG. 10, diagonal line 1002 originating from \tilde{x}ₖ^{(c)} denotes the direction and slope (given by δ_{eƒƒ}^{(c)}) of the penalization.

The partition function can be calculated as the sum of the partition functions in the two segments. For the first segment, the result in case 3 can be used, and in the second segment, the result of case 1 can be used, with both adapted to the segment domains. The partition function is then:

$${Z}_{β}^{k} = {\sum }_{n = l b [ k ]}^{⌊ {x}_{k}^{( c )} ⌋} exp [ - β {δ}_{eff} n ] + {\sum }_{n = ⌈ {\tilde{x}}_{k}^{( c )} ⌉}^{u b [ k ]} exp \{ - β [ {δ}_{eff} n + {λ}_{c} {{δ}_{eff}^{( c )} ( n - {\tilde{x}}_{k}^{( c )} )}^{α} ] \} .$$

Considering the case with δ_{eƒƒ}^{(c)}<0, cases 1 and 3 will be swapped, as well as the segments in case 2.

Generalizing the partition function to the case of multiple constraints, the ordered set of binding values {\tilde{x}ₖ^{(c)}}_{c=1, . . . ,C} defines a set of segments {S≡[xₛ, xₛ₊₁]}. As above, the partition function can be computed over a segment and the partition functions of all segments can be summed. For each segment the contributing constraints are tracked. These are given by the constraints c for which δ_{eƒƒ}^{(c)}>0 and \tilde{x}ₖ^{(c)}<xₛ and also those for which δ_{eƒƒ}^{(c)}<0 and \tilde{x}ₖ^{(c)}>xₛ₊₁.

Denoting this set of constraints as C_{S}, the partition function for a segment s is given by:

Z_{β}^{k,(S)}=Σₙ₌ₓ_{ₛ}^{x}^{ₛ₊}1 exp {−β[δ_{eƒƒ}n+Σ_{c∈C}_{ₛ}λ_{c}δ_{eƒƒ}^{(c)}(n−\tilde{x}ₖ^{(c)})^{a}]}. (4)

This general case is illustrated in FIG. 11.

For the L₀ penalization, where α=0, the partition function becomes:

$${Z}_{β}^{k , ( s )} = exp \{ - β {\sum }_{c ∈ {C}_{s}} {λ}_{c} {δ}_{eff}^{( c )} \} {\sum }_{n = {x}_{s}}^{{x}_{s + 1}} exp \{ - β {δ}_{eff} n \} = \{ \begin{matrix}exp \{ - β {\sum }_{c ∈ {C}_{s}} {λ}_{c} {δ}_{e f f}^{( c )} \} ( {e}^{- β {δ}_{e f {f}^{{x}_{s}}}} - {e}^{- β {δ}_{e f f} ( {x}_{s + 1} + 1 )} ) {( 1 - {e}^{- {βδ}_{eff}} )}^{- 1} , if {δ}_{e f f} > 0 , \\ exp \{ - β {\sum }_{c ∈ {C}_{s}} {λ}_{c} {δ}_{e f f}^{( c )} \} ( {e}^{- β \vert {δ}_{e f f} \vert {x}_{s + 1}} - {e}^{- β \vert {δ}_{e f f} \vert ( {x}_{s} - 1 ) )} ) {( 1 - {e}^{- β \vert {δ}_{e f f} \vert} )}^{- 1} , if {δ}_{e f f} < 0 .\end{matrix}$$

For the L₁ penalization, an analytic expression of the partition function can be provided, as the linear dependence of the violation can be incorporated in the objective function bias. This obtains:

Σ_{β}^{k,(S)}=exp {βΣ_{C∈C}_{ₛ}λ_{c}δ_{eƒƒ}^{(c)}\tilde{x}ₖ^{(c)}}Σₙ₌ₓ_{ₛ}^{x}^{ₛ₊}1 exp {-β[δ_{eƒƒ}+Σ_{c∈C}_{ₛ}λ_{c}δ_{eƒƒ}^{(c)}]n},

The results for the L₀ penalization can be used by changing the pre-factors and setting δ_{eƒƒ}→δ_{eƒƒ+Σ}_{c∈C}_{ₛ}λ_{c}δ_{eƒƒ}^{(c)}.

The partition function for L₀ and L₁ can therefore be written in a uniform way by defining, for each segment s, a linear penalty LPS with offset ω and slope σ as:

$$L {P}_{s} [ ω ] = \{ \begin{matrix}{\sum }_{c ∈ {C}_{s}} {λ}_{c} {δ}_{e f f}^{( c )} i f α = 0 \\ - {\sum }_{c ∈ {C}_{s}} {λ}_{c} {δ}_{eff}^{( c )} {\tilde{x}}_{k}^{( c )} if α = 1\end{matrix} \qquad ( 6 )$$

$$And$$

$${LP}_{s} [ σ ] = \{ \begin{matrix}{δ}_{e f f} if α = 0 \\ [ {δ}_{e f f} + {\sum }_{c ∈ {C}_{s}} {λ}_{c} {δ}_{e f f}^{( c )} ] if α = 1\end{matrix} \qquad ( 7 )$$

And write the partition function as:

$${Z}_{β}^{k , ( s )} = {e}^{- β ω} {\sum }_{n = {x}_{s}}^{{x}_{s + 1}} {e}^{- β σ n} = \{ \begin{matrix}{e}^{- β ω} ( {e}^{- β σ {x}_{s}} - {e}^{- β σ ( {x}_{s + 1} + 1 )} ) {( 1 - {e}^{- β σ} )}^{- 1} if σ > 0 \\ {e}^{- β ω} ( {e}^{- β \vert σ \vert {x}_{s + 1}} - {e}^{- β \vert σ \vert ( {x}_{s} - 1 )} ) {( 1 - {e}^{- β \vert σ \vert} )}^{- 1} if σ < 0\end{matrix} . \qquad ( 8 )$$

### Inverse Transform Sampling

Sampling from within a selected segment may be performed using various techniques, for example, using inverse transform sampling. In the following, inverse transform sampling is described for integer and continuous variables. Let x be a continuous random variable with values in the segmentx∈[x_{L}, x_{U}]. With reference to the above discussion, x_{L} and x_{U} can be taken as segment bounds xₛ,xₛ+1, respectively. The partition function for a segment can be generically written as:

$$Z ( λ ) = {\int }_{{x}_{L}}^{{x}_{U}} dx exp ( - λ x ) = \frac{1}{λ} [ exp ( - λ {x}_{L} ) - exp ( - λ {x}_{U} ) ]$$

The cumulative distribution function can be calculated as:

$$F ( x ) = {\int }_{{x}_{L}}^{{x}_{U}} {dx}^{′} exp ( - λ {x}^{′} ) = \frac{exp ( - λ {x}_{L} ) - exp ( - λ x )}{exp ( - λ {x}_{L} ) - exp ( - λ {x}_{U} )} = \frac{1 - exp [ - λ ( x - {x}_{L} ) ]}{1 - exp ( - λ R )}$$

where R is defined as R=x_{U}−x_{L}. This formula can be inverted

$$F ( x ) = y yields : x = {x}_{L} - \frac{1}{λ} ln [ 1 + y ( {e}^{- λ R} - 1 ) ] \qquad ( 9 )$$

To sample a continuous variable within the segment [x_{L},x_{U}] with the distribution exp[−λₓ], a variable γ that is uniformly distributed in [0,1] can be sampled randomly, and then equation (9) used.

The integer case may be sampled similarly, the cumulative distribution function is given by:

$$F ( x ) = {\sum }_{n = {x}_{L}}^{x} exp [ - {λ}_{n} ] = \{ \begin{matrix}\frac{1 - exp [ - λ ( x - {x}_{L} + 1 ) ]}{1 - exp ( - λ R )} λ > 0 \\ \frac{1 - exp [ - λ ( x - {x}_{U} - 1 ) ]}{1 - exp ( - \vert λ \vert R )} λ < 0\end{matrix} \qquad ( 10 )$$

Where here R=x_{U}−x_{L}+1. The two cumulative distribution functions (9) and (10) are identical up to a displacement+1. In equation (10), argument x is an integer, so passing from a continuous random variable γ ∈[0,1) requires the use of the floor and ceiling functions. Setting F(x)=γ, the inverse of equation (10) yields:

$$x = \{ \begin{matrix}{x}_{L} + ⌊ - \frac{1}{λ} ln [ 1 - y ( 1 - {e}^{- λ R} ) ] ⌋ if λ > 0 , \\ {x}_{U} + ⌈ \frac{1}{\vert λ \vert} ln [ 1 - y ( 1 - {e}^{- \vert λ \vert R} ) ] ⌉ if λ < 0 .\end{matrix}$$

The above-described techniques for integer variables will now be discussed with reference to FIG. 3 and method 300. As discussed above, method 300 is an implementation of a method of operation of a computing system to update a sample in an optimization algorithm to improve convergency to feasibility. It will be understood that the above-described techniques for integer variables may similarly be applied to any of the methods discussed herein.

At 302, the processor receives a problem definition with a set of variables, an objective function defined over the set of variables, and one or more constraint functions, each of the constraint functions defined by at least one variable of the set of variables. In the present implementation, at least one variable of the set of variables is an integer variable.

At 304, sample values are received by the processor for the set of variables. This may be based on some known properties of the system, may be provided by another algorithm, may be randomly selected, or may be provided by other techniques as will be recognized by those of skill in the art. A value for a progress parameter, such as a temperature in the case of simulated annealing, is also received.

At 306, the processor selects a variable from the set of variables. For the purpose of this example, only integer variables will be discussed. However, this method may also be applied to continuous variables. Other variable types may be updated as discussed in further detail above. It will be understood that the order of acts 308 to 318 may be varied from the order shown in FIG. 3, as discussed in further detail below.

At 308, the variable type is determined. In this example, the variable type is determined to be integer.

At 310, a sampling distribution is selected for the integer variables. As discussed above, there is not a single well-defined distribution that may be selected for integer variables. Instead, Gibbs sampling, referring to a technique for sampling from a conditional distribution, is performed. The sampling distribution is selected to be the conditional distribution given by the conditional partition function.

At 312, an objective energy change bias on the sample value for the variable and one or more terms of the objective function that include the variable is determined. As discussed above, for an integer variable this is calculated as the effective linear bias of the variable xₖ, and is given by δ_{eƒƒ}=aₖ−Σ_{i≠k}wᵢₖxᵢ.

At 314, a constraint energy change based on the sample value for the variable and each of the constraint functions defined by the variable is determined. This is given by δ_{eƒƒ}^{(c)}=aₖ^{(c)}−Σ_{i≠k}wᵢₖ^{(c)}xᵢ.

At 318, an updated value is sampled for the variable based on the objective energy change and the constraint energy change as discussed above. The updated value may also be selected based on the current value of each constraint and the type of each constraint as above. In particular, if none of the constraints contribute to the linear bias for a given variable (δ_{eƒƒ}^{(c)}=0), then the new integer value is sampled from the partition function of the objective function, as given by equations (2) and (3) above. If the constraints do contribute to the linear bias, segments are created where the bias values from the constraints have the same value or are well defined. A segment is randomly chosen with a probability proportional to its partition function, and then a new integer value is randomly sampled from within that segment. The partition function of each segment is computed based on equation (8) above, and is based on the total energy change given by δ_{eƒƒ}and δ_{eƒƒ}^{(c)} and the progress parameter β.

At 320, it is determined if all of the variables have been considered. If there are other integer variables, the process above for sampling is repeated. If there are other types of variables, sampling is performed as described above.

At 322, an updated sample is returned, the updated sample comprising the updated value for each variable of the set of variables.

### Continuous Variables

As discussed above, constrained problems may be defined over different variable types, such as binary, discrete, integer, and continuous. The variable types may determine the sampling distribution selected by the processor. In the above discussion of integer variables, there may not be a single well defined sampling distribution. Similarly, for continuous variables, there may not be a single well defined sampling distribution. Continuous variables can take on any two particular real values, and can also take on all real values between those two values. For example, a continuous variable may take any value over the range of real numbers. Many types of optimization problems include decision variables that are represented by continuous variables. Some examples of such continuous variables include weight, volume, pressure, temperature, speed, flow rate, and elevation level.

One method of addressing continuous variables in optimization problems is using discretization of the continuous variables to represent the continuous variables using a set of integer or binary variables, and using the techniques described above for the redefined variable type. However, discretization of continuous variables may not provide a computationally efficient solution. For example, conversion of continuous variables into integer variables may require an infinite upper bound to model continuous variables with arbitrary precision. Integer variables with infinite bounds may not be practical to implement in many applications. Using binary variables may similarly significantly increase the size of the problem, resulting in inefficient solving.

### Inverse Transform Sampling for Continuous Variables

As mentioned above, the inverse transform sampling method for integer variables can be readily adapted for continuous variables, with the main differences being how the partition function is calculated and how the segments are split. The partition function for continuous variables can be written as:

$${Z}_{β}^{k} = {\int }_{Ib [ k ]}^{ub [ k ]} dx exp \{ - β f ( x \vert {\{ {x}_{i} \}}_{i \neq k} ) \} = {\int }_{l b [ k ]}^{ub [ k ]} dx exp \{ - β [ A + {δ}_{e f f} x ] ) \} = exp \{ - β A \} \frac{exp \{ - β {δ}_{e f f} l b [ k ] \} - exp \{ - β {δ}_{e f f} u b [ k ] \}}{β {δ}_{e f f}}$$

The prefactor exp {−βA} can be ignored and the partition function can be calculated analytically without the need to distinguish the two cases δ_{eƒƒ}>0 or δ_{eƒƒ}<0.

When considering a constraint g_{c} adjacent to variable xₖ, this will split the domain [lb [k], ub[k]] in two domains depending on where the binding value \tilde{x}ₖ^{(c)}−−Aₖ^{(c)}/δ_{eƒƒ}^{(c)}. Here we briefly consider the case where lb[k]≤\tilde{x}ₖ^{(c)}≤ub[k]. In this case, if δ_{eƒƒ}>0, the partition function is given by:

Σ_{β}^{k}=ƒ_{lb[k]}^{\tilde{x}}^{ₖ}^{^{(c)}}dxexp {−β[δ_{eƒƒ}x]}+ƒ_{\tilde{x}}_{ₖ}_{^{(c)}}^{ub[k]}dxexp {−β[δ_{eƒƒ}x+λ_{c}δ_{eƒƒ}^{(c)}(x−\tilde{x}ₖ^{(c)})a]}.

Comparing the expression above with the integer counter-part demonstrates how sums are replaced by integrals and the binding values floor and ceiling functions are removed. When considering multiple constraints, the partition function is given by:

$${Z}_{β}^{k , ( s )} = {\int }_{{x}_{x}}^{{x}_{s + 1}} dx exp \{ - β [ {δ}_{e f f} x + {\sum }_{c ∈ {C}_{s}} {λ}_{c} {{δ}_{e f f}^{( c )} ( x - {\tilde{x}}_{k}^{( c )} )}^{α} ] \} .$$

Even in this case, we can use a uniform way to calculate the partition function for the L₀ and L₁ penalizations analytically. For the L₀ penalization we have:

$${Z}_{β}^{k , ( s )} = exp \{ - β {\sum }_{c ∈ {C}_{s}} {λ}_{c} {δ}_{e f f}^{( c )} \} \frac{exp \{ - β {δ}_{e f {f}^{{x}_{S}}} \} - exp \{ - β {δ}_{e f f} {x}_{s + 1} \}}{β {δ}_{e f f}} \qquad ( 9 )$$

while for the L₁ penalization we have:

Σ_{β}^{k,(s)}=exp {βΣ_{c∈C}_{ₛ}λ_{c}δ_{eƒƒ}^{(c)}}{exp[−β(δ_{eƒƒ}+Σ_{c∈C}_{ₛ}λ_{c}δ_{eƒƒ}^{(c)}xₛ]−exp[−β(δ_{eƒƒ}+Σ_{c∈C}_{ₛ}λ_{c}δ_{eƒƒ}^{(c)})xₛ+1]}/{β[δ_{eƒƒ}+Σ_{c∈C}_{ₛ}λ_{c}δ_{eƒƒ}^{(c)}]} (10)

The methods described above use inverse transform sampling or similar sampling methods over segments, and cannot be used for variables (integer or continuous) that have quadratic cases.

The cumulative distribution function can be inverted analytically only for cases having linear (x) or bi-linear (x×γ) terms. In the case of quadratic (x²) terms, inverting the cumulative distribution function involves significant computational overhead such as the requirement to calculate the error function (erf(x)) or the imaginary error function (ierf(x)). Slice sampling may beneficially be performed in order to sample from the conditional distribution function without the requirement to invert the cumulative distribution function. In some implementations, slice sampling may be used only for variables that are not included in other methods described herein. However, in other implementations, this method may be used to sample integer and continuous variables having linear, bi-linear, and quadratic interactions. This may also accommodate interactions between continuous variables and other types of variables.

Similar to the implementation discussed above, consider the case where there is a constrained quadratic model (CQM) with binary, integer, and continuous variables. LetB⊆{1, . . . , n} denote the set of indices of the binary variables, that is, xᵢ∈{0,1} if i ∈B. Similarly, letC⊆{1, . . . , n} denote the set of indices of continuous variables, that is, xᵢ∈

[symbol]

if i ∈C, and let I ⊆{1, . . . , n} denote the set of indices of integer variables, that is, xᵢ∈ [symbol]
if i ∈

The CQM assumes the form:
Minimize: Σᵢaᵢxᵢ+Σ_{i≤j}bᵢⱼxᵢxⱼ,
Subject to: Σᵢaᵢ^{(c)} xᵢ+Σ_{i≤j}bᵢⱼ^{(c)}xᵢxⱼ+c^{(c)}≤0
lb[k]≤xᵢ≤ub[k]

The term Σ_{i≤j}bᵢⱼxᵢxⱼ includes the pure quadratic term bᵢᵢxᵢ², although it is noted that for binary variables xᵢ²≡xᵢ.

Consider the model without constraints, when updating the variable xₖ, where κ ∈C or κ ∈I. In an implementation with an annealing solver and Gibbs sampling, the conditional probability distribution function of variable xₖ given the values of the other variables {xᵢ}_{i≠k}can be written as P(xₖ|{xᵢ}_{i≠k}) ∝exp {−β[bₖₖxₖ²+δₖxₖ+Aₖ]}, where β is the inverse temperature at which a given increment of the optimization algorithm (e.g., annealing solver) is performed, δₖ is the effective linear bias of variables xₖ and Aₖ is a constant factor that includes the constant d and the contribution of other variables {xᵢ}_{i≠k}. β increases as the annealing proceeds.

If bₖₖ=0 then the sampling for integer or continuous variables can be performed using the method discussed above for integer variables as there is no quadratic term. The cumulative distribution function of p(x)=exp(−*Ax) can be inverted for both integer and continuous variables. When bₖₖ≠0, however, the function is no longer easily invertible. An implementation of sampling for quadratic terms and mixed variable interactions will be described below.

In the case of quadratic terms and mixed variable interactions, sampling for a given variable may be performed by slice sampling. A general description of slice sampling is provided in Neal, R., Slice Sampling, The Annals of Statistics, 2003, Vol. 31, No. 3, 705-767. Slice sampling generally is a Markov chain Monte Carlo algorithm for drawing random samples by sampling uniformly from the region under the graph of a variable's density function. For a given value of a variable x₀, an auxiliary variable γ is sampled uniformly between 0 and ƒ(x₀). A point (x,y) can be sampled from the line (or slice) at γ where it is under the curve of ƒ(x₀). The value of x from the sampled point becomes the updated value for the variable x. While slice sampling is described below, it will be understood that in other implementations, inverse transform sampling may be used with the aid of the Newton-Raphson method, the bisection method, or other methods known in the art.

For a CQM problem, based on a current value of variable xₖ, which can be denoted as xₖ, a value γ can be sampled uniformly from between 0 and P(xₖ)=exp {−β[bₖₖ(xₖ⁰)²+δₖxₖ⁰+Aₖ]}, as given above. A new value for xₖ can then be uniformly sampled from the region X={xₖ: P(xₖ) ≥γ}.

Let μ˜RAND (0,1) be a random number between 0 and 1. The condition exp {−β[bₖₖ(xₖ⁰)²+δₖxₖ⁰+Aₖ]}≥γ can be written as Axₖ²+Bxₖ+C≤0, where A βbₖₖ,B≡βδₖ, C=βAₖ+Inμ+In P(xₖ⁰). These last two terms in the definition of C are provided by Iny ≡In[μ·P(xₖ⁰)]=lnμ+In P(xₖ⁰). Assuming xₖ is a continuous variable, solving this inequality yields two values, x₁≤x₂ that are the zeros of the inequality.

There are two cases:

In the connected region where xₖ ∈[x₁, x₂] with x₁≥lb[k] and x₂ ub[k]. The new value of xₖ can be uniformly sampled from [x₁, x₂].

In the disconnected region where xₖ ∈[lb[k],x₁] V xₖ ∈[x₂,ub[k]], one of the two disconnected regions is selected with a probability proportional to x₁−lb[k] and [x₂, ub [k]]. A new value for xₖ is uniformly sampled from the chosen region.

In the case where variable xₖ is integer, the two values x₁, x₂ are replaced with x₁,x₂→[x₁], [x₂] in the connected region and x₁,x₂→[x₁], [x₂] in the disconnected region.

Turning now to constraints, “less than” inequalities will be discussed below. It will be understood that “greater than” equalities can be addressed similarly, and equality constraints can be addressed as a combination of two inequality constraints.

Considering the case of one constraint:

$${\sum }_{i} {a}_{i}^{( c )} {x}_{i} + {\sum }_{i \leq j} {b}_{i j}^{( c )} {x}_{i} {x}_{j} + {c}^{( c )} \leq 0$$

As above, when updating variable xₖ (which may be an integer or continuous variable), the other variables are fixed. The constraint can be written as:

bₖₖ^{(c)}xₖ²+δₖ^{(c)}xₖ+Aₖ^{(c)}≤0

δₖ^{(c)}≡aₖ^{(c)}+Σ_{i≠k}bᵢₖ^{(c)}xᵢ

Aₖ^{(c)}≡Σ_{i,i≠k}aᵢ^{(c)}xᵢ+Σ_{i,j≠k}bᵢⱼ^{(c)}xᵢxⱼ+c^{(c)}

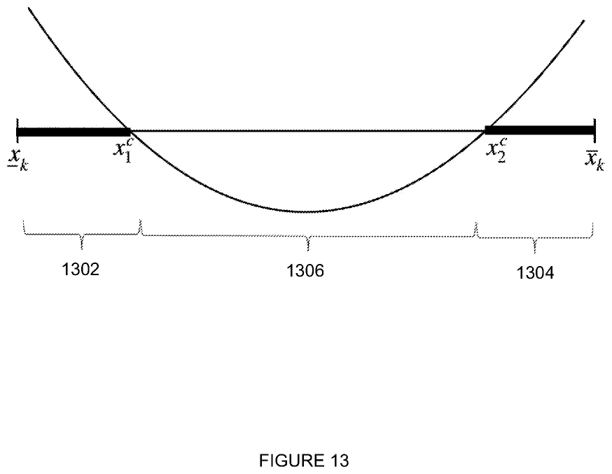

The solution of this inequality yields a maximum of two solutions, which can be denoted as x₁, x₂, with the assumption that x₁^{c}<x₂^{c}. These are also referred to as binding values in the discussion above. The sign of bₖₖ^{(c)} will determine if the region [x₄, x] is feasible (that is, satisfies the constraints). See FIG. 13, which shows an example implementation of a probability distribution function for a continuous variable.

Where bₖₖ>0 the two solutions of the inequality are such that lb[k]<x₁^{c}<x₂^{c}<ub [k]. The inequality is satisfied in the segment [x₁^{c}, x₂^{c}] (the parabola is below the axis). This is shown as region 1306 in FIG. 13. Three segments can be defined: [lb[k],x₁^{c}] where the inequality is not satisfied and the probability of sampling the variable xₖ should be suppressed (region 1302 in FIG. 13), [x₁^{c}, x₂^{c}] where the inequality is satisfied and thus the probability of sampling xₖ is not suppressed (region 1306 in FIG. 13), and [x₂^{c}, ub [k]] where the inequality is violated and the probability is suppressed (region 1304 in FIG. 13). Introducing a lagrangian λ_{c}>0 for the constraint, the un-normalized probability distribution function can be written as:

$$P ( {x}_{k} = n ) ∝ \{ \begin{matrix}exp \{ - β [ {b}_{kk} {n}^{2} + {δ}_{k} n + {A}_{k} + {λ}_{c} ( {b}_{kk}^{( c )} {n}^{2} + {δ}_{k}^{( c )} n + {A}_{k}^{( c )} ) ] \} if n ∈ [ l b [ k ] , {x}_{1}^{c} ] ⋁ n ∈ [ {x}_{2}^{c} , ub [ k ] ] \\ exp \{ - β [ {b}_{kk} {n}^{2} + {δ}_{k} n + {A}_{k} ] \} if n ∈ [ {x}_{1}^{c} , {x}_{2}^{c} ]\end{matrix}$$

The lagrangian coefficient (penalty parameters) may be provided to penalize infeasible solutions as discussed above in further detail, and in particular with reference to methods 800 and 900. The suppressed case can also be written as

P(xₖ=n)∝exp {−β[an²+bn+c]}

With

a=bₖₖ+λ_{c}bₖₖ^{(c)}

b=δ^{k}+λ_{c}δₖ^{(c)}

c=Aₖ+λ_{c}Aₖ^{(c)}

The next value for variable xₖ will then be sampled as follows: given the current value of the variable xₖ⁰, the un-normalized probability distribution function is calculated and denoted as P₀=P(xₖ⁰). A slide γ can be sampled uniformly in γ˜U(0,P₀). For each of the segments the subregions Sᵢ that are above the slice γ are calculated, that is:

S₁={x∈[lb([k],x₁^{c}]|P(x)≥γ}

S₂={x∈[x₁^{c},x₂^{c}]|P(x)≥γ}

S₃={x∈[x₂,ub[k]]|P(x)>γ}

Each Sᵢ can be empty (in case every x in the segment has P(x)<γ) or disconnected, as above. Each of these subregions will be accompanied by an (un-normalized) probability pᵢ that is the width of the region (for continuous variables) or the number of integers within the region (for integer variables). A sub-region will be selected with probability

$$\frac{{p}_{i}}{{\sum }_{j} {p}_{j}} .$$

The next value will be uniformly sampled from the selected region. Sampling from a selected segment can be performed by inverse transform sampling, or other sampling techniques as known in the art.

It will be understood that these principles can be extended to cases where there are no solutions to the equality above, with all of the domain suppressed accordingly, as well as to the case where there is only one solution (x₁^{c}=x₂^{c}). The above can also be generalized to cases where one or both of x₁^{c}, x₂^{c} are outside the variable domain [xₖ,x̅ₖ]In the case of multiple constraints, the domain of variable xₖ can be divided into a set of segments where some constraints are violated. After sampling a slice γ, the method will proceed similarly to the implementation described above, with each segment being divided into sub-regions where P(x)>γ. One of the sub regions is then sampled with a probability according to the total width of the sub region (or number of integers), and the new value of variable xₖ is sampled uniformly from within the selected sub-region.

L₂, norm penalization

In the discussions above with respect to integer variables, sampling for constraint functions is described with respect to the L₀ and L₁ norms. The general partition function for a segment s is given by:

$${Z}_{β}^{k , ( s )} = {\sum }_{n = {x}_{s}}^{{x}_{s + 1}} exp \{ - β [ {δ}_{eff} n + {\sum }_{c ∈ {C}_{s}} {λ}_{c} {{δ}_{eff}^{( c )} ( n - {\tilde{x}}_{k}^{( c )} )}^{α} ] \} .$$

For the L₂ norm of the violation constraint, where a=2, inverse transform style sampling cannot be performed as the expression above will contain quadratic terms. However, slice sampling, as discussed above, can be used to accommodate the use of the L₂ norm for cases where the constraints have linear or bilinear terms. It will be understood that for constraints having quadratic terms the L₂ penalization would yield up to quartic terms, which is beyond the scope of the discussion below. Additional modification of the methods described herein may be required to accommodate quartic cases, or the L₀ and L₁ norms may be used in these cases.

Given a constraint with no quadratic terms, that is, bₖₖ^{c}=0, the constraint for variable xₖ can be rewritten as Aₖ+δₖ^{c}xₖ<0. Assuming 8ₖ≥0, the probability to sample xₖ>\tilde{x}ₖ^{c}=−Aₖ^{c}/Sₖ^{c} can be suppressed according to:

P(xₖ=n>\tilde{x}ₖ^{c})∝exp {−β[δₖ^{c}(n−\tilde{x}ₖ^{c})²]}

The square in the exponential can be expanded as above. The slice sampling procedure described above can be used to sample a new value for xₖ.

### Pseudocode:

An example implementation of the methods described above will now be described.

Input: A CQM, a state x on the CQM, the current Lagrangian multiplier Ae for each constraint c, the current energy value E[c] for each constraint c, inverse temperature β, and the integer variable xₖ to be updated.

The effective bias function is defined given a state, variable, and constraint as: δ_{eƒƒ,k}^{c}=a_{c,k}+Σ_{i≠k}w_{ki,c}xᵢ (leaving out the constraint argument c just returns to the effective bias due to the main CQM objective). Note that in the definition of the effective bias the subscript k indicates that the quantity is recomputed for every variable xₖ and for each adjacent constraint c.

In one example implementation, the following structures are defined:
‘QuadraticPenalty’, with the properties ‘quadratic’, ‘linear’ and ‘offset’ (all real numbers) that encode the quantities introduced in the linear penalty equations defined above. This is used to describe a quadratic penalty with quadratic and linear coefficients, where ‘offset’ is the value of the penalty at xₖ=0.

The addition operation is also defined as: Given two ‘QuadraticPenalty’ objects QP1 and QP2, define QP=QP1+QP2 such that:
QP.quadratic=QP1.quadratic+QP2.quadratic
   QP.linear=QP1.linear+QP2.linear
   QP.offset=QP1.offset+QP2.offset.
‘ConstraintPoint’, with properties ‘value’ (an integer), ‘left’ and ‘right’ (both ‘QuadraticPenalty’). This describes a point along the domain of xᵢ at which one or more penalties changes to a different quadratic function. The ‘value’ refers to the value of xₖ, and ‘left’ and ‘right’ refer to the different quadratic penalties (or sums of quadratic penalties) that become 0 closest to ‘value’. ‘left’ refers to penalties coming from the negative direction of the domain of xₖ which have negative ‘slope’, and ‘right’ refers to penalties going to the positive direction of the domain with positive ‘slope’. For two ‘ConstraintPoint’ objects CP1 and CP2 the addition is defined only if CP1.value==CP2.value. If this is satisfied, CP=CP1+CP2 is set with CP.value=CP1.value, CP.left=CP1.left+CP2.left, and CP.right=CP1.right+CP2.right.
‘PartialSegment’ with the properties ‘lower_bound’ (an integer) and ‘quadratic penalty’ (a ‘QuadraticPenalty’). This corresponds to the starting point of each segment (segments as defined in the mathematical formulation section above) and the total quadratic penalty that is applied to the variable in the portion of the segment that follows the lower bound.
‘Segment’ with properties ‘lower_bound’ ‘upper bound’, and “quadratic penalty”.

In one example implementation, the algorithm proceeds with:

Subroutine 1:

```
sample_integer_continuous_variable
  Inputs:
  inverse temperature beta
  current state x
  variable xk to update
  lagrangians list
  CQM model
  Initialize 2 empty arrays of ConstraintPoint objects called tmp_constraints and constraints
  Initialize empty array of PartialSegment objects called partial_segments
  Initialize empty array of Segment objects called segments
  FROM THE OBJECTIVE FUNCTION GET quadratic_bias, linear_bias
  IF xk is an integer variable THEN:
    update_integer = 1
  ELSE:
    update_integer = 0
  END IF
  num_active_constraints = 0
  FOR each constraint c adjacent to variable xk DO:
    lagrangian is the lagrangian parameter
    tmp_constraints, num_active_constraints = PARSE_CONSTRAINT(c, lagrangian,
  update_integer, tmp_constraints, xk_lower, xk_upper, num_active_constraints)
  END FOR
  SORT tmp_constraints by value and then by left and right penalty, quadratic first, offset
  last.
```

| | |
|---|---|
| constraints, num_constraints | = COLLAPSE_CONSTRAINTS(tmp_constraints, |

```
  num_active_constraints)
  partial_segments, num_partial_segments = MAKE_PARTIAL_SEGMENTS(quadratic_bias,
  linear_bias, lower_bound, upper_bound,
```

| | |
|---|---|
| | collapsed_constraints, num_collapsed_constraints, |
| | partial_segments, update_integer) |
| segments, num_segments | = MAKE_SEGMENTS(partial_segments, |

num_partial_segments, lower_bound, upper_bound,

segments, update_integer)

```
  new_value = SAMPLE_VALUE_FROM_SEGMENTS(segments, num_segments, beta)
  RETURN new_value
```

The next subroutine parses the constraint c, that is, extracts either the binding value \tilde{x}ₖ^{(c)} or the two values x₁^{c} and x₂^{c} (the binding values) depending on if the constraint is linear or quadratic respectively and generates up to 2 constraint points:

Subroutine 2:

```
PARSE_CONSTRAINT
  Inputs:
  constraint c
  lagrangian
  update_integer
  tmp_constraints
  num_active_constraints
  lower_bound
  upper_bound
From the constraint c, get the quadratic coefficient b_kk, the effective linear bias delta_k and
the offset A_k
  IF b_kk = 0 THEN
    # linear constraint
    IF delta_k == 0 THEN
      skip this constraint
    END IF
    xc = -delta_k / A_k
    if update_integer THEN
      IF delta_k > 0 THEN
        xc = CEIL(xc)
      ELSE
        xc = FLOOR(xc)
      END IF
    END IF
    IF using L0 penalty THEN
      QP = QUADRATIC_PENALTY(0, 0, lagrangian*abs(delta_k))
    ELSE IF using L1 penalty THEN
      QP = QUADRATIC_PENALTY(0, lagrangian*delta_k, -lagrangian*delta_k*xc)
    ELSE IF using L2 penalty THEN
      QP = QUADRATIC_PENALTY(lagrangian*delta_k ** 2 , -lagrangian*delta_k*A_k,
lagrangian*A_k ** 2)
    END IF
    CP = ConstraintPoint(xc)
    IF delta_k > 0 THEN
      CP.right = QP
    ELSE
      CP.left = QP
    END IF
    tmp_constraints[num_active_constrains] = CP
    num_active_constraints ++
  ELSE
    # The constraint is quadratic.
    # Here x1 and x2 are sorted if they are real
    x1, x2 = SOLVE_QUADRATIC_EQUATION(b_kk, delta_k, A_k)
    IF (x1 <= x2) AND (x1, x2 are real) THEN
      IF b_kk > 0 THEN
        IF update_integer THEN
          x1 = CEIL(x1)
          x2 = FLOOR(x2)
        END IF
        IF using L0 penalty THEN
          QP = QUADRATIC_PENALTY(0, 0, lagrangian)
        ELSE IF using L1 penalty THEN
          QP = QUADRATIC_PENALTY(lagrangian*b_kk, lagrangian*delta_k,
lagrangian*A_k)
        END IF # cannot use L2 penalty in this case
        CP = ConstraintPoint(x1)
        CP.left = QP
        tmp_constraints[num_active_constrains] = CP
        num_active_constraints ++
        CP = ConstraintPoint(x2)
        CP.right = QP
        tmp_constraints[num_active_constrains] = CP
        num_active_constraints ++
      ELSE IF b_kk < 0 THEN
        IF update_integer THEN
          x1 = FLOOR(×1)
          x2 = CEIL(x2)
        END IF
        IF using L0 penalty THEN
          QP = QUADRATIC_PENALTY(0, 0, lagrangian)
        ELSE IF using L1 penalty THEN
          QP = QUADRATIC_PENALTY(lagrangian*b_kk, lagrangian*delta_k,
lagrangian*A_k)
        END IF
        CP = ConstraintPoint(x1)
        CP.right = QP
        tmp_constraints[num_active_constrains] = CP
        num_active_constraints ++
        CP = ConstraintPoint(x2)
        CP.left = -QP
        tmp_constraints[num_active_constrains] = CP
        num_active_constraints ++
      END IF
    ELSE IF x1, x2 are complex THEN
      IF b_kk > 0 THEN
        # the constraint is always violated
        IF using L0 penalty THEN
          QP = QUADRATIC_PENALTY(0, 0, lagrangian)
        ELSE IF using L1 penalty THEN
          QP = QUADRATIC_PENALTY(lagrangian*b_kk, lagrangian*delta_k,
lagrangian*A_k)
        END IF
        CP = ConstraintPoint(lower_bound)
        CP.right = QP
        tmp_constraints[num_active_constrains] = CP
        num_active_constraints ++
      END IF
    END IF
  END IF
  RETURN tmp_constraints, num_active_constraints
```

The following subroutine scans the tmp_constraints and makes sure that if there are two or more constraint points within the same value, only one that is the sum of them remains:

Subroutine 3:

```
COLLAPSE_CONSTRAINTS
  Inputs:
  tmp_constraints
  num_active_constraints
  constraints
  Set num_collapsed_constraints = 0
  current_constraint = tmp_constraints[0]
  FOR c_i = 1, num_active_constraints-1 DO
    next_constraint = tmp_constraints[c_i]
    IF current_constraint.value == next_constraint.value THEN
      current_constraint = current_constraint + next_constraint
    ELSE
      constraints[num_collapsed_constraints] = current_constraint
      current_constraint = next_constraint
      num_collapsed_constraint ++
    END IF
  END FOR
  constraints[num_collapsed_constraints] = current_constr
  num_collapsed_constraint ++
  RETURN constraints, num_collapsed_constraints
```

The following subroutine creates the partial segments, that is, the points after which the conditional probability distribution function changes the coefficients.

Subroutine 4:

```
MAKE_PARTIAL_SEGMENTS
  Inputs:
  quadratic_bias
  linear_bias
  lower_bound
  upper_bound
  collapsed_constraints
  num_collapsed_constraints
  partial_segments
  update_integer
  // L1 case
  penalty_sum = QUADRATIC_PENALTY(quadratic_bias, linear_bias, 0);
  FOR i=0, num_collapsed_constraints-1 DO
    IF collapsed_constraints [i].value < lower_bound THEN
      penalty_sum += collapsed_constraints[i].right
    ELSE
      penalty_sum += collapsed_constraints[i].left
    END IF
  END FOR
  current_value = lower_bound
  num_partial_segments = 0
  FOR i=0, num_collapsed_constraints-1 DO
    IF collapsed_constraints[i]. value < lower_bound THEN
      CONTINUE
    END IF
    IF collapsed_constraints[i].value > lower_bound + update_integer THEN
      BREAK
    END IF
    IF collapsed_constraints[i].right is present THEN
      IF current_value != collapsed_constraints[i].value THEN
        partial_segments[num_partial_segments].lower_bound = current_value
        partial_segments[num_partial_segments].quadratic_penalty = penalty_sum;
        num_partial_segments++;
      END IF
      current_value = collapsed_constraints[i].value
      penalty_sum += collapsed_constraints[i].right
    END IF
    IF collapsed_constraints[i].left is present THEN
      partial_segments[num_partial_segments].lower_bound = current_value
      partial_segments[num_partial_segments].quadratic_penalty = penalty_sum;
      current_value = constraints[i].value + update_integer;
      penalty_sum -= constraints[i].left;
      num_partial_segments++;
    END IF
  END FOR
  partial_segments[num_partial_segments].lower_bound = current_value
  partial_segments[num_partial_segments].quadratic_penalty = penalty_sum
  num_partial_segments++
  RETURN partial_segments, num_partial_segments
```

The following subroutine creates the segments from the array of partial segments created by the subroutine above:

Subroutine 5:

```
MAKE_SEGMENTS
  Inputs:
  partial_segments
  num_partial_segments
  lower_bound
  upper_bound
  segments
  update_integer
  num_segments = num_partial_segments − 1;
  segment_idx = 0;
  IF num_segments > 0 THEN
      FOR i=0, num_partial_segments-2 DO
        IF partial_segments[i].lower_bound >= lower_bound THEN
          segments [segment_idx].lower_bound = partial_segments[i].lower_bound
          segments [segment_idx].upper_bound = partial_segments[i + 1].lower_bound −
update_integer
          segments[segment_idx].quadratic_penalty =
partial_segments[i].quadratic_penalty
          segment_idx++
        ELSE
          num_segments -= 1
        END IF
      END FOR
  ELSE
      # in case there are no partial segments
    num_segments++;
      segments[0].lower_bound = partial_segments[0].lower_bound;
      segments[0].upper_bound = partial_segments[0].lower_bound;
      segments[0].quadratic_penalty = partial_segments[0].quadratic_penalty;
  END IF
  RETURN segments, num_segments
```

The final subroutine samples a value from a segment, and varies based on if the variable is integer (6a) or continuous (6b).

```
Subroutine 6a:
SAMPLE_VALUE_FROM_SEGMENTS
  Inputs:
  beta
  current_value
  segments
  num_segments
  update_integer
  FOR each segment DO
    IF update_integer THEN
      calculate the segment partition function with equation (8)
    ELSE
      calculate the segment partition function with equations (9, 10)
    END IF
  END FOR
  SAMPLE one segment with probability proportional to its partition
  function
  SAMPLE new value using inverse transform sampling method on this
  segment
  RETURN new value
Subroutine 6b:
SAMPLE_VALUE_FROM_SEGMENTS
  Inputs:
  beta
  current_value
  segments
  num_segments
  update_integer
  calculate log f0 from the segment that contains current_value
  SAMPLE u = RAND(0,1)
  FOR each segment DO
    calculate subregions where P(x) >= f0
    set probability of each subregions proportional to its size
  END FOR
  SAMPLE one subregion randomly according to respective probability
  SAMPLE uniformly new value from the selected subregion
  RETURN new value
```

In an alternative implementation, sampling for continuous variables may be done from a linear programming model with the values for the variables of other types (i.e., discrete, integer, and binary) fixed. This may beneficially allow for solving a CQM having continuous variables without the addition of multiple variables to the problem, and may result in convergence of continuous variables towards an optimal solution at a similar rate to the convergence of the other problem variables. When solving an optimization problem, where the variable type is continuous, sampling may be performed based on a linear programming model. Linear programming, also called linear optimization, is a mathematical model for variables having linear relationships. Methods for solving linear programming problems are well known in the art.

After each sweep of an optimization algorithm such as simulated annealing, a linear programming problem can be created by fixing the values of the integer, binary, and discrete variables to their updated sampled values. A solution for the linear programming problem can then be found to define updated values for the continuous variables of the overall problem. The general structure of the linear problem does not change at each stage of the optimization algorithm, and thus there may beneficially be low overhead to solving the linear programming model at each stage. This may beneficially reduce the computational requirements of solving for continuous variables, as building a new linear programming model at each stage may introduce a large overhead, particularly where numerous iterations are required for convergence of the optimization algorithm.

In an implementation, optimization may proceed according to various implementations as discussed above for any integer, binary, or discrete variables in the problem. Updated values may also be sampled for variables having quadratic interactions, or interactions between continuous variables and other variable types, such as by slice sampling as discussed above. Once updated values for these variables have been sampled, the remaining continuous variables may have values sampled from a linear programming problem with the values for the other variables fixed at their updated values.

It will be understood that a linear programming model as described below does not support quadratic interactions between continuous variables, or interactions between continuous variables and other variable types. It will be further understood that in some implementations, a combination of sampling from the conditional probability distribution as discussed above, and sampling from a linear programming model may be used. For example, continuous variables having quadratic terms or interactions with other variable types may be sampled as discussed above using sampling from the conditional probability distribution through slice sampling. These continuous variables may then be fixed, along with the other variable types, and the remaining continuous variables may have values sampled from a linear programming model as discussed in further detail below.

FIG. 14 is a flow diagram of an example method of operation of a computing system for finding a solution to a constrained problem or other problem that may be expressed as a constrained quadratic model, or for generating sample solutions that may be used as inputs to other algorithms, the problems having one or more continuous variables. FIG. 14 shows method 1400. Method 1400 may be executed on a hybrid computing system comprising at least one digital or classical processor and a quantum processor, for example hybrid computing system 100 of FIG. 1, or by a classical computing system comprising at least one digital or classical processor.

Method 1400 comprises acts 1402 to 1444; however, a person skilled in the art will understand that the number of acts illustrated is an example, and, in some implementations, certain acts may be omitted, further acts may be added, and/or the order of the acts may be changed.

Method 1400 starts at 1402, for example in response to a call or invocation from another routine or in response to an input by a user.

At 1402, the processor receives a problem definition. The problem definition includes a set of variables, an objective function defined over the set of variables, and one or more constraint functions, each of the constraint functions defined by at least one variable of the set of variables. The problem definition may be received from a user (e.g., entered via an input device), transmitted from another processor, retrieved from memory, or provided as the output of another process performed by the processor. The objective function may be a quadratic function, and the problem definition may define a quadratic optimization problem. The set of variables may contain one or more of continuous, discrete, binary, and integer variables. The constraint functions may include one or more quadratic equality or inequality constraint functions.

In one implementation, the problem definition may be defined by:

$$minimize f = {\sum }_{i} {a}_{i} {x}_{i} + {\sum }_{i , j} {b}_{i , j} {x}_{i} {x}_{j} + {\sum }_{l} {e}_{l} {y}_{l}$$

with constraints defined by:

$${E}_{m} = {\sum }_{i} {a}_{i , m}^{′} {x}_{i} + {\sum }_{i , j} {b}_{i , j , m}^{′} {x}_{i} {x}_{j} + {\sum }_{l} {e}_{l , m}^{′} {y}_{l} + {c}_{m} \leq 0 ∀ m ∈ M$$

Where xᵢ are a set of discrete variables (which may include integer and binary variables, xᵢ ∈Z), aᵢ are linear coefficients for the discrete variables, b_{i,j} are quadratic coefficients between discrete variables, a_{i,m}′ are linear coefficients for discrete variables for constraint m, b_{i,j,m}′ are quadratic coefficients between discrete variables m, and cₘ is a constant, as discussed above, and where γₗ are continuous variables (γₗ ∈ [symbol] ), eₗ are linear biases for the continuous variables, e_{l,m}′ are linear coefficients for the continuous variables for constraint m, and Eₘ is the energy of constraint m.

The problem definition above does not include quadratic interactions between continuous variables and other variables. This model may beneficially be used to model mixed integer linear programming (MILP) problems, as well as some cases of mixed integer quadradic programming (MIQP) problems.

At 1404, the processor initializes a sample solution to the objective function. The sample solution may be a random solution to the objective function. The random solution may be randomly selected from across the entire variable space, or the random solution may be selected within a range of the variable space based on known properties of the problem definition or other information. The sample solution may also be generated by another algorithm or provided as input by a user.

At 1406, the processor initializes a progress parameter. The progress parameter may be a set of incrementally changing values that define an optimization algorithm. For example, the progress parameter may be an inverse temperature, and the inverse temperature may increment from an initial high temperature to a final low temperature. In some implementations, an inverse temperature is provided as a progress parameter for a simulated annealing algorithm. The selection of an inverse temperature may be performed as described above.

At 1408, the processor optionally initializes a penalty parameter. In some implementations the penalty parameter may be a Lagrange multiplier as discussed in further detail below. In other implementations the penalty parameter may be selected as a constant value or a value that depends on one or more other variables.

At 1410, the processor initializes a linear programming problem for the continuous variables using the initial states of the variables defined at act 1404.

Considering the problem formulation above, given:

$$minimize f = {\sum }_{i} {a}_{i} {x}_{i} + {\sum }_{i , j} {b}_{i , j} {x}_{i} {x}_{j} + {\sum }_{l} {e}_{l} {y}_{l}$$

As above, the constraints may be restated as:

$${\sum }_{l} {e}_{l , m}^{′} {y}_{l} \leq - {\sum }_{i} {a}_{i , m}^{′} {x}_{i} - {\sum }_{i , j} {b}_{i , j , m}^{′} {x}_{i} {x}_{j} - {c}_{m} ∀ m ∈ M$$

The portions of the problem defined by the discrete, integer, and continuous variables may be set to a constant value (CO, Cₘ), to provide a linear programming model:

$$minimize f = {\sum }_{l} {e}_{l} {y}_{l} + C 0$$

With the constraints:

$${\sum }_{l} {e}_{l , m}^{′} {y}_{l} \leq {C}_{m} ∀ m ∈ M$$

As discussed above, penalty parameters may also be included in the model, giving:

$$minimize f = {\sum }_{l} {e}_{l} {y}_{l} + {\sum }_{m} {L}_{m} {v}_{m} + C 0$$

With the constraints:

$${\sum }_{l} {e}_{l , m}^{′} {y}_{l} - {v}_{m} \leq {C}_{m} ∀ m ∈ M$$

Where Lₘ is a Lagrange multiplier, also referred to as a penalty parameter as discussed above, and νₘ is the magnitude of the current violation for constraint m. The model may beneficially be built prior to the start of the optimization algorithm, and does not require reconstruction after each stage of the optimization. The general model structure (also called the model rim) does not change, beneficially allowing for the model to be updated and solved quickly. The part of the model that does change is the portion defined by the objective function and the fixed variables (the right-hand side of the equations above), which can be calculated after each update of these variables.

At 1412, the processor optionally calculates a current value of each constraint function at the sample values. For example, constraint functions may be given as ΣA_{c,i}xᵢ+b_{c}=0, or as inequalities, depending on the constraints provided.

At 1414, the processor increments a stage of an optimization algorithm, such as by providing the progress parameter to the optimization algorithm. Optimization algorithms may include simulated annealing, parallel tempering, Markov Chain Monte Carlo techniques, branch and bound algorithms, and greedy algorithms, which may be performed by a classical computer. Optimization algorithms may also include algorithms performed by a quantum computer, such as quantum annealing, quantum approximate optimization algorithm (QAOA) or other noisy intermediate-scale quantum (NISQ) algorithms, quantum implemented fault-tolerant optimization methods, or other quantum optimization algorithms.

Quantum computers may include quantum annealing processors or gate model based processors. On successive iterations the incremented optimization algorithm may provide samples.

At iteration k of the optimization algorithm (e.g., simulated annealing), sampling is performed for each integer, binary, and discrete variable as discussed below and in greater detail above, with the problem being considered with the values of the continuous variables fixed from the previous iteration (k−1):

$$minimize f = {\sum }_{i} {a}_{i} {x}_{i} + {\sum }_{i , j} {b}_{i , j} {x}_{i} {x}_{j} + {\sum }_{l} {e}_{l}^{′} {y}_{l}^{k - 1}$$

$$With {\sum }_{i} {a}_{i , m}^{′} {x}_{i} + {\sum }_{i , j} {b}_{i , j , m}^{′} {x}_{i} {x}_{j} + {\sum }_{l} {e}_{l , m}^{′} {y}_{m}^{k - 1} + {c}_{m} \leq 0 ∀ m ∈ M$$

$${x}_{i} ∈ Z and {y}_{l} ∈ R , {y}_{l} \geq 0$$

At 1416, the processor selects an i^{th} variable from a first set of variables of the set of variables. The first set of variables can include any integer, binary, or discrete variables, with a second set of variables including any continuous variables. The i^{th} variable has a current value from the sample initialized at act 1404.

At 1418, the processor determines a variable type for the variable. The variable type may be, for example, one of binary, discrete, and integer. It will be understood that a problem may contain a mixture of these types of variables, only one of these types of variables, and combinations thereof.

At 1420, the processor selects a sampling distribution based on the variable type. In some implementations, where the variable type is binary, the sampling distribution selected may be the Bernoulli distribution. In other implementations, where the variable type is discrete, the sampling distribution selected may be the SoftMax distribution. Alternatively, in some implementations, discrete variables may be included as binary variables using one-hot constraints and the sampling distribution may be the Bernoulli distribution. In other implementations, where the variable type is integer, sampling may be performed by Gibbs sampling, that is, sampling on the conditional probability given the current state. Alternatively, Gibbs sampling may be performed on all variable types, with the conditional probability function being determined by the variable type. Integer variables may also be transformed to binary variables and sampling from the Bernoulli distribution may be performed. Sampling for integer and continuous variables may also be done by slice sampling as above.

At 1422, the processor determines an objective energy bias acting on the variable under consideration given the current values of all of the other variables. As discussed above, an optimization problem may be structured with an objective function that defines an energy, and during optimization a processor returns solutions with the goal of reducing this energy. In some implementations, such as where the variable under consideration is a binary variable, an objective energy change (A_{E}) may be determined based on the energy of the previous solution and the energy of the current sample value, with a decrease in energy suggesting an improved solution.

At 1424, the processor determines a constraint energy bias acting on the variable under consideration given the current values of all of the other variables and each of the constraint functions that involves the variable. A constraint energy bias may be defined by Δ_{E}=Σ_{c}(|δ_{c,1}|ⁿ−|δ_{c,0}|ⁿ) for binary variables, as discussed above. The penalty applied to each constraint may be determined by the magnitude of the violation. In some implementations, the processor determines a total energy change based on the objective energy change and the constraint energy change. The constraint functions are indirectly included in this energy by the processor by the addition of an energy term considering the constraints.

At 1426, the processor samples an updated value for the variable from the sampling distribution based on the objective and constraint energy biases and the progress parameter as discussed in further detail above.

At 1428, the processor evaluates if all of the variables of the first set of variables have been considered. If all of the variables have not been considered, control passes back to act 1416, and the next variable is selected. Once all of the variables have been considered, control passes to act 1430. In some implementations, the processor may incrementally consider each variable in turn of the first set of variables and evaluate that all of the variables of the first set of variables have been considered when the last variable of the first set of variables has been considered.

At 1430, the processor fixes the values of the first set of variables based on their updated values from above.

At 1432, the processor solves the linear programming problem for the continuous variables in the second set of variables and samples updated values for the continuous variables. The linear programming problem can be solved using any technique known in the art, such as using an interior-point method or a simplex algorithm.

When considering the continuous variables, sampling is performed with the values for the integer, binary, and discrete variables fixed. That is, using a given integer/binary state at iteration k, that is, variable xᵢ^{k}, the following linear programming problem is used to sample values for the continuous variables:

$$minimize f = {\sum }_{i} {a}_{i} {x}_{i}^{k} + {\sum }_{i , j} {b}_{i , j} {x}_{i}^{k} {x}_{j}^{k} + {\sum }_{l} {e}_{l} {y}_{l} + {u}_{m} {q}_{m}$$

$${\sum }_{i} {a}_{i , m}^{′} {x}_{i}^{k} + {\sum }_{i , j} {b}_{i , j , m}^{′} {x}_{i}^{k} {x}_{j}^{k} + {\sum }_{l} {e}_{k , m}^{′} {y}_{k , m} - {q}_{m} + {c}_{m} \leq 0 ∀ m ∈ M$$

In the equations above, qₘ is a positive continuous variable and μₘ is a Lagrange multiplier. qₘ is added to the left-hand side of each constraint to avoid infeasibility in the linear programming problem. qₘ is then penalized and added to the objective function at the current value of the Lagrange multiplier. The linear programming solver defines the value of qₘ alone with the problem continuous variables. This relaxation technique avoids infeasibility, but is penalized.

At each stage of the optimization algorithm, the structure of the linear programming problem does not change, but the right-hand side of the constraints and the coefficient for the variable qₘ are updated.

For large scale problems the linear programming problem may beneficially be split into multiple smaller linear programming problems (subproblems) where the continuous variables are randomly assigned to one of the subproblems. The assignment may also be optimized to reduce the number of interactions between variables in different subproblems. When sampling for a variable in a given subproblem, the values of the continuous variables in all other subproblems are fixed at their most recent value. This may beneficially allow for convergence of continuous variables to near optimum or global optimum points at the same rate as other variables.

For example, given G as the set of continuous variables, the variables may be randomly split into N groups with equal sizes Gₙ={xᵢ|i in Gₙ}. Variables and constraints can be defined for each group, and a linear programming problem can be built for each variable and constraint group. Each linear programming problem may then be solved sequentially, with the related variables being updated.

At 1434, the processor updates the states for the continuous variables based on the results of the linear programming problem.

At 1436, the processor updates the energy biases for the objective and constraint functions based on the sampled values for the continuous variables.

At 1438, the processor increments the progress parameter, e.g., the temperature for simulated annealing.

At 1440, optionally, the penalty parameter for each constraint may be adjusted. In some implementations the penalty parameter may be adjusted based on the change in energy for the constraint function defined by the i^{th} variable and the progress parameter. In other implementations, the penalty parameter may be adjusted as described in methods 800 and 900, discussed in further detail below.

At 1442, the processor evaluates one or more termination criteria. In some implementations, the termination criteria may be a value of the progress parameter. In other implementations, the termination criteria may include a number of iterations, an amount of time, a threshold average change in energy between updates, a measure of the quality of the current values for the variables, or other metrics as are known in the art. If the termination criteria are not met, the method continues with act 1414. As discussed above, incrementing a stage of an optimization algorithm for the objective function may include incrementing a simulated annealing or parallel tempering algorithm. In other implementations the optimization algorithm may be a MCMC algorithm or a greedy algorithm.

If the one or more termination criteria has been met, control passes to 1444, where a solution is output. At 1444, method 1400 terminates, until it is, for example, invoked again. The solution output at act 1444 may be passed to other algorithms, such as a quantum annealing algorithm.

In some implementations, after outputting a solution at act 1444, method 1400 may begin again with a new sample being initialized at act 1404. In some implementations, method 1400 may be performed multiple times in parallel starting from different initialized samples or a series of randomly generated samples. In some implementations, the solutions may be paired, and binary problems may be built to evaluate the series of solutions using Cross-Boltzmann updates.

An example implementation is described in the following pseudocode, which may be combined with the pseudocode discussed above.

```
Pseudocode:
  For iteration k = 0
  initialize β, L^{k}, x^{k}, y^{k}
      x initialized randomly, y is initialized to zero
  calculate Eₘ^{k} = compute_energy(x^{k}, y^{k})
  While sweeping:
    Eₘ^{k+1}, x^{k+1} ← sample discrete
      update energy:
      ${E}_{m}^{k + 1} = {\sum }_{l} {e}_{l , m}^{′} {y}_{l}^{k} + {\sum }_{i} {a}_{i , m}^{′} {x}_{i}^{k + 1} + {\sum }_{i , j} {b}_{i , j , m}^{′} {x}_{i}^{k} {x}_{j}^{k + 1} + {c}_{m}$
    Eₘ^{k+1}, y^{k+1} ← solve for continuous and update energy
${rhs}_{m} = {E}_{m}^{k + 1} - {\sum }_{l} {e}_{l , m}^{′} {y}_{l}^{k}$
      update LP objective with L^{k}
      yₗ^{k+1} ← solve LP (rhsₘ, L^{k})
      ${E}^{k + 1} = {E}^{k + 1} + {\sum }_{l} {e}_{l , m}^{′} {y}_{l}^{k} - {\sum }_{l} {e}_{l , m}^{′} {y}_{l}^{k + 1} = {rhs}_{m} + {\sum }_{l} {e}_{l} {y}_{l}^{k + 1}$
```

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:
U.S. Provisional Patent Application No. 62/951,749;
U.S. Provisional Patent Application No. 63/174,097;
U.S. Provisional Patent Application No. 63/250,466;
U.S. Patent Application Publication Nos. 2014/0344322 and 2020/0234172; and
U.S. Pat. Nos. 7,533,068; 8,008,942; 8,195,596; 8,190,548; and 8,421,053.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operation of a computing system to update a sample in an optimization algorithm to improve convergence to feasibility, the method being performed by a processor, the method comprising:
receiving a problem definition comprising a set of variables, an objective function defined over the set of variables, and one or more constraint functions, each of the constraint functions defined by at least one variable of the set of variables;
receiving sample values for the set of variables and a value for a progress parameter;
for each variable of the set of variables:
determining a variable type for the variable;
selecting a sampling distribution based on the variable type;
determining an objective energy bias based on the sample value for the variable and one or more terms of the objective function that include the variable;
determining one or more constraint energy biases based on the sample value for the variable and each of the constraint functions defined by the variable; and
sampling an updated value for the variable from the sampling distribution based on the objective energy bias, the one or more constraint energy biases, and the progress parameter; and
returning an updated sample, the updated sample comprising the updated value for each variable of the set of variables.

2. The method of claim 1, further comprising: receiving a value for a penalty parameter, and wherein sampling an updated value for the variable from the sampling distribution further comprises sampling an updated value for the variable from the sampling distribution based on the value for a penalty parameter.

3. The method of claim 2, wherein receiving a value for the penalty parameter comprises receiving a value for a Lagrange parameter that depends on the value for the progress parameter.

4. The method of any one of claims 1 through 3, wherein determining the variable type for the variable comprises determining that the variable type is one of binary, discrete, integer, or continuous.

5. The method of claim 4, wherein determining that the variable type is one of binary, discrete, integer, or continuous comprises determining that the variable type is binary, and wherein selecting a sampling distribution based on the variable type comprises selecting a Bernoulli distribution.

6. The method of claim 4, wherein determining that the variable type is one of binary, discrete, integer, or continuous comprises determining that the variable type is discrete, and wherein selecting a sampling distribution based on the variable type comprises selecting a SoftMax distribution.

7. The method of claim 4, wherein determining that the variable type is one of binary, discrete, integer, or continuous comprises determining that the variable type is one of integer or continuous, and wherein selecting a sampling distribution based on the variable type comprises selecting a conditional probability distribution.

8. The method of claim 7, wherein sampling an updated value for the variable from the sampling distribution comprises slice sampling from the conditional probability distribution.

9. The method of any one of claims 1 through 8, wherein receiving the value for the progress parameter comprises receiving an inverse temperature.

10. A system for updating a sample in an optimization algorithm, the system comprising:
at least one non-transitory processor-readable medium that stores at least one of processor executable instructions and data; and
at least one processor communicatively coupled to the least one non-transitory processor-readable medium, which, in response to execution of the at least one of processor executable instructions and data performs the method of any of claims 1 through 9.

11. A method of operation of a computing system, the computing system comprising one or more processors, the method being performed by at least one of the one or more processors, the method comprising:
receiving a problem definition comprising a set of variables, an objective function defined over the set of variables, and one or more constraint functions, each of the constraint functions defined by at least one variable of the set of variables;
initializing a sample solution to the objective function and a progress parameter;
iteratively until a termination criteria is met:
incrementing a stage of an optimization algorithm;
for each variable in the set of variables:
selecting an i^{th} variable from the set of variables, the i^{th} variable having a current value;
calculating an objective energy bias for the objective function based on the current value of the i^{th} variable;
calculating a constraint energy bias for each constraint function defined by the i^{th} variable based on the current value of the i^{th} variable; and
sampling an updated value for the i^{th} variable based on the objective energy bias and the constraint energy bias, the updated value replacing the current value;
incrementing a progress parameter;
evaluating a termination criteria; and
outputting a solution comprising the current values for the set of variables.

12. The method of claim 11, wherein:
selecting an i^{th} variable from the set of variables comprises selecting a binary variable, the binary variable having a current value and an alternative value;
calculating an objective energy bias for the objective function based on the current value of the i^{th} variable comprises calculating a difference in energy for the objective function between the current value and the alternative value for the binary variable;
calculating a constraint energy bias based on each constraint function defined by the i^{th} variable based on the current value of the i^{th} variable comprises calculating a difference in energy for each constraint function defined by the binary variable between the current value of the binary variable and the alternative value for the binary variable; and
sampling an updated value for the i^{th} variable based on the objective energy bias and the constraint energy bias comprises sampling an updated value for the i^{th} variable based on the difference in energy values for the objective function and each constraint function defined by the i^{th} variable.

13. The method of claim 12, further comprising:
initializing a penalty parameter; and
adjusting the penalty parameter for each constraint function based on the difference in energy for the constraint function defined by the iP variable and the progress parameter; and
wherein calculating the difference in energy for each constraint function defined by the i^{th} variable includes penalizing each constraint function by the penalty parameter.

14. The method of any one of claims 11 through 13, wherein incrementing a stage of an optimization algorithm for the objective function includes incrementing one of a simulated annealing or a parallel tempering algorithm.

15. The method of any one of claims 11 through 14, wherein receiving a problem definition comprising an objective function and one or more constraint functions comprises receiving a problem definition comprising a quadratic objective function and one or more quadratic equality or inequality constraint functions.

16. The method of any one of claims 11, 14, and 15, wherein receiving a problem definition comprising a set of variables comprises receiving a problem definition comprising a set of one or more of binary, integer, or discrete variables.

17. The method of claim 16, wherein receiving a problem definition comprising a set of variables comprises receiving a problem definition comprising one or more integer variables, and wherein sampling an updated value for the i^{th} variable comprises performing sampling from a conditional probability distribution, the i^{th} variable comprising an integer variable from the one or more integer variables.

18. The method of any one of claims 11 through 17, wherein the termination criteria comprises one of a number of iterations, an amount of time, an average change in value limit, or a value of the progress parameter.

19. A system for use in optimization, the system comprising:
at least one non-transitory processor-readable medium that stores at least one of processor executable instructions and data; and
at least one processor communicatively coupled to the least one non-transitory processor-readable medium, which, in response to execution of the at least one of processor executable instructions and data, performs the method of any of claims 11 through 18.

20. The system of claim 19, further comprising a quantum processor, and wherein, after performing the method of any of claims 11 through 18, the at least one processor instructs the quantum processor to perform quantum annealing based on the outputted solution.

21. A method of operation of a hybrid computing system, the hybrid computing system comprising a quantum processor and a classical processor, the method being performed by the classical processor, the method comprising:
receiving a constrained quadratic optimization problem, the constrained quadratic optimization problem comprising a set of variables, an objective function defined over the set of variables, one or more constraint functions, each of the constraint functions defined by at least one variable of the set of variables, and a progress parameter for the optimization, the progress parameter comprising a set of values incrementing between an initial value and a final value;
iteratively until the final value of the progress parameter is reached:
sampling a sample set of values for the set of variables from an optimization algorithm;
updating the sample set of values with an update algorithm comprising:
for each variable of the set of variables:
determining a variable type for the variable;
selecting a sampling distribution based on the variable type;
determining an objective energy bias based on a sample value for the variable from the sample set of values and one or more terms of the objective function that include the variable;
determining one or more constraint energy bias based on the sample value for the variable and each of the constraint functions defined by the variable; and
sampling an updated value for the variable from the sampling distribution based on the objective energy bias, the one or more constraint energy biases, and the progress parameter; and
returning an updated sample, the updated sample comprising the updated value for each variable of the set of variables;
incrementing the progress parameter;
transmitting one or more final samples to a quantum processor;
instructing the quantum processor to refine the samples; and
outputting solutions.

22. The method of claim 21, wherein transmitting one or more final samples to a quantum processor comprises transmitting pairs of samples to the quantum processor, and wherein instructing the quantum processor to refine the samples comprises instructing the quantum processor to perform quantum annealing to select between the samples.

23. The method of any one of claims 21 and 22, further comprising: returning the outputted solutions as a sample set of values for the set of variables as an input to the optimization algorithm.

24. A hybrid computing system, the hybrid computing system comprising:
a quantum processor and a classical processor;
at least one non-transitory processor-readable medium that stores at least one of processor executable instructions and data; and
at least one processor communicatively coupled to the least one non-transitory processor-readable medium, which, in response to execution of the at least one of processor executable instructions and data, performs the method of any of claims 21 through 23.

25. A method of operation of a computing system to direct a search space towards feasibility to improve performance of the computing system, the computing system comprising one or more processors, the method being performed by at least one of the one or more processors, the method comprising:
receiving a sample from an optimization;
determining an energy value for one or more constraint functions;
evaluating feasibility of the sample;
if the sample is not feasible, increasing a penalty value;
if the sample is feasible, decreasing a penalty value; and
returning a penalty value to an optimization algorithm.

26. The method of claim 25, further comprising: determining if a violation has been reduced in comparison with a previous sample and increasing an initial adjuster value if the violation has not been reduced.

27. The method of any one of claims 25 and 26, further comprising: determining if a current best solution has been improved in comparison with a previous sample and increasing an initial adjuster value if the current best solution has not been improved.

28. A method of operation of a computing system, the computing system comprising one or more processors, the method being performed by at least one of the one or more processors, the method comprising:
receiving a problem definition comprising a set of variables, an objective function defined over the set of variables, and one or more constraint functions, each of the constraint functions defined by at least one variable of the set of variables, the set of variables comprising a first subset of variables having at least one variable that is one of binary, integer, discrete, or continuous and a second subset of variables having at least one variable that is continuous;
initializing a sample solution to the objective function and a progress parameter;
initializing a continuous problem defined over the second subset of variables, the continuous problem comprising a linear programming model;
iteratively until a termination criteria is met:
incrementing a stage of an optimization algorithm;
for each variable in the first subset of variables:
determining a variable type for the variable;
selecting a sampling distribution based on the variable type;
determining an objective energy bias based on the sample value for the variable and one or more terms of the objective function that include the variable;
determining one or more constraint energy biases based on the sample value for the variable and each of the constraint functions defined by the variable;
sampling an updated value for the variable from the sampling distribution based on the objective energy bias, the one or more constraint energy biases, and the progress parameter; and
returning an updated sample, the updated sample comprising the updated value for each variable of the set of variables;
solving the linear programming model for the second subset of variables with the values for each variable in the first subset of variables fixed at the updated value;
sampling an updated value for each variable in the second subset of variables based on the solved linear programming model, the updated value replacing a current value;
updating the objective energy bias and the one or more constraint energy biases based on the updated values for the second subset of variables;
incrementing the progress parameter;
evaluating a termination criteria; and
outputting a solution comprising the updated values for the set of variables.

29. The method of claim 28, further comprising:
initializing one or more penalty parameters;
wherein sampling an updated value for the variable from the sampling distribution further comprises sampling an updated value for the variable from the sampling distribution based on at least one value for the one or more penalty parameters; and
wherein sampling an updated value for each variable in the second subset of variables comprises sampling an updated value for each variable in the second subset of variables based on the solved linear programming model and at least one value for the one or more penalty parameters.

30. The method of claim 29, wherein initializing one or more penalty parameters comprises initializing at least one Lagrange parameter that depends on the value for the progress parameter.

31. The method of any one of claims 28 through 30, wherein determining the variable type for the variable comprises determining that the variable type is one of binary, discrete, integer, or continuous.

32. The method of claim 31, wherein determining that the variable type is one of binary, discrete, integer, or continuous comprises determining that the variable type is binary, and wherein selecting a sampling distribution based on the variable type comprises selecting a Bernoulli distribution.

33. The method of claim 31, wherein determining that the variable type is one of binary, discrete, integer, or continuous comprises determining that the variable type is discrete, and wherein selecting a sampling distribution based on the variable type comprises selecting a SoftMax distribution.

34. The method of claim 31, wherein determining that the variable type is one of binary, discrete, integer, or continuous comprises determining that the variable type is one of integer or continuous, and wherein selecting a sampling distribution based on the variable type comprises selecting a conditional probability distribution.

35. The method of claim 34, wherein sampling an updated value for the variable from the sampling distribution comprises slice sampling from the conditional probability distribution.

36. The method of any one of claims 28 through 35, wherein receiving the value for the progress parameter comprises receiving an inverse temperature.

37. The method of any one of claims 28 through 36, wherein incrementing a stage of an optimization algorithm for the objective function includes incrementing one of a simulated annealing or a parallel tempering algorithm.

38. The method of any one of claims 28 through 37, wherein receiving a problem definition comprising an objective function and one or more constraint functions comprises receiving a problem definition comprising a quadratic objective function and one or more quadratic equality or inequality constraint functions.

39. The method of any one of claims 28 through 38, wherein the termination criteria comprises one of a number of iterations, an amount of time, an average change in value limit, or a value of the progress parameter.

40. A system for use in optimization, the system comprising:
at least one non-transitory processor-readable medium that stores at least one of processor executable instructions and data; and
at least one processor communicatively coupled to the least one non-transitory processor-readable medium, which, in response to execution of the at least one of processor executable instructions and data, performs the method of any of claims 28 through 39.

41. The system of claim 40, further comprising a quantum processor, and wherein, after performing the method of any of claims 28 through 39, the at least one processor instructs the quantum processor to perform quantum annealing based on the outputted solution.
